(19) United States
(12) Patent Application Publication
(10) Pub. No.: US 2017/0026983 A1
(43) Pub. Date: Jan. 26, 2017

(54) BASE STATION APPARATUS

(71) Applicant: FUJITSU LIMITED, Kawasaki-shi (JP)

(72) Inventors: Norio MURAKAMI, Yokohama (JP); Yoshio MASUDA, Kawasaki (JP)

(21) Appl. No.: 15/287,484

(22) Filed: Oct. 6, 2016

Related U.S. Application Data
(63) Continuation of application No. PCT/JP2014/060495, filed on Apr. 11, 2014.

(51) Int. Cl. H04W 72/12; H04W 4/02; H04W 8/02; H04W 28/24; H04L 5/00

(52) U.S. Cl. CPC H04W 72/12; H04W 28/24; H04L 5/0035; H04W 8/02; H04W 4/028; H04W 88/08

(57) ABSTRACT

A base station apparatus that performs radio communication with a terminal apparatus, the base station apparatus including: a receiver configured to receive information from the terminal apparatus; and a processor configured to perform radio communication in cooperation with another base station apparatus based on the information, for a region in which the terminal apparatus is located.

### CROSS-REFERENCE TO RELATED APPLICATION

This application is a continuation application of International Application Number PCT/JP2014/060495 filed on Apr. 11, 2014 and designated the U.S., the entire contents of which are incorporated herein by reference.

### FIELD

The embodiments discussed herein are related to a base station apparatus.

### BACKGROUND

A radio communication system such as a mobile telephone system and a wireless LAN (Local Area Network) is currently in wide use. Also, in the field of radio communication, a next generation communication technology is under continuous discussion in order to further improve a communication speed and a communication capacity. For example, in the 3GPP (3rd Generation Partnership Project), an association for standardization, the standardization of communication standards called LTE (Long Term Evolution) and LTE-A (LTE-Advanced) based on the LTE is completed or currently under study.

One of technologies related to such radio communication includes Coordinated Multi-Point transmission and reception (which may hereafter be referred to as “cooperative communication” or “CoMP”). The cooperative communication is, for example, such a technology that a plurality of base station apparatuses perform radio communication with one terminal apparatus in a cooperative manner. For example, if the cooperative communication is executed for a terminal apparatus which is located in an overlapped region between a communicable region (which may be referred to as a “cell” or a “cell range”, for example) of a certain base station apparatus and a cell range of another base station apparatus, the throughput of the terminal apparatus can be improved, so that improved communication performance can be attained.

As typical technologies for use for the cooperative communication, there are a Joint Processing (which may hereafter be referred to as “JP”) scheme and a Coordinated Beamforming (which may hereafter be referred to as “CB”)/Coordinated Scheduling (which may hereafter be referred to as “CS”) scheme.

According to the JP scheme, data is transmitted from a plurality of transmission points to a terminal apparatus, for example. By the JP scheme, for example, the terminal apparatus can receive data from a plurality of base station apparatuses, so that can obtain better reception quality as compared to the case of receiving data from a single base station apparatus.

Additionally, in regard to the JP scheme, there are a Joint Transmission (which may hereafter be referred to as “JT”) scheme and a Dynamic Point Selection (which may hereafter be referred to as “DPS”) scheme, for example. According to the JT scheme, for example, data are simultaneously transmitted from a plurality of points. On the other hand, according to the DPS scheme, data is transmitted from one point when viewed momentarily.

Further, the CB/CS scheme includes the CB scheme and the CS scheme, in which data transmission is executed from one base station apparatus, for example, whereas beamforming and the determination of scheduling are executed in cooperation among a plurality of base station apparatuses. For example, using the CB/CS scheme, an antenna provided in a certain base station apparatus is directed to a terminal apparatus, and a radio resource is allocated to the terminal apparatus, so that interference to the terminal apparatus can be reduced.

As a technique related to such cooperative communication, for example, there is a technique as follows.

Namely, there is a radio communication system in which a terminal determines PMI (precoding matrix index) set information when operated in the CB scheme and phase set information for beam phase correction when operated in the JP scheme, and transmits the above determined information to a serving base station.

According to the above technique, it is said that a method for integrated feedback information transfer, which a terminal can adaptively use according to a variety of transfer modes, can be proposed.

Further, there is a radio communication system in which a user terminal measures first reception quality in a first transmission section when a macro base station is either in a non-transmission state or performing transmission with reduced power, and also measures second reception quality in a second transmission section when the macro base station and a power node perform transmission, and transmits the measured results to the macro base station. In this case, based on the first and second reception quality, the macro base station is configured to allocate a radio resource for a user terminal, located at a cooperative area end, to the first section.

According to the above technique, it is said that, when CoMP transmission is applied in a heterogeneous network, an influence of a characteristic deterioration caused by interference can be reduced, so that can improve a throughput.

Further, there is a radio base station cooperation system in which two radio base stations, when transmitting the data with a tolerable delay time which can be buffered, to a terminal located at a cell end, transmit a radio resource allocation request to a base station cooperation apparatus, and reserve a radio resource for a terminal on the basis of an allocation notification from the base station cooperation apparatus. In this case, in response to the allocation request from the two radio base stations, the base station cooperation apparatus allocates the radio resource by scheduling in a manner not to cause interference, to notify the two base stations.

According to the above technique, it is said that a radio base station cooperative system, capable of cooperative scheduling between the base stations if there is a delay in the transmission of a control signal between the base stations, can be obtained.

Further, there is a method for a cellular system in which a first part of a bandwidth is used for transmission to a UE in which CoMP is not effective, whereas a second part of the bandwidth is used for transmission to a UE in which CoMP is effective.

According to the above technique, it is said that complexity is reduced and flexibility is given to UE and/or BS included in the cellular system.

Further, there is a coordinated multi-point transmission and reception system in which a measurement report is reported when a terminal satisfies an event report trigger criterion. In this case, the event report trigger criterion is based on when the travel speed measurement value of a service cell is lower than a preset first measurement threshold, and when a ratio of an RSRP measurement value of a measurement cell to an RSRP measurement value of the service cell is lower than a preset second measurement threshold.

According to the above technique, it is said that an optimal solution method can be presented for a threshold when a center user switches to a CoMP mode and an event report trigger criterion.

Further, there is a mobile communication method in which a radio base station sets a CoMP transmission point using an RRC signal, to activate and deactivate the transmission point set by a MAC-CE signal. In this case, a mobile station is configured to transmit the CQI (Channel Quality Indicator) of the activated transmission point whereas does not transmit the CQI of the deactivated transmission point.

According to the above technique, it is said that unnecessary feedback of CQI is avoided when CoMP transmission/reception processing is performed.

### CITATION LIST

### Non-Patent Literature

[Non-patent document 1] 3GPP TR36.819 V11.1.0 (2011-12)

### Patent Literature

[Patent document 1] Japanese National Publication of International Patent Application No. 2013-509082.

[Patent document 2] Japanese Laid-open Patent Publication No. 2012-042342.

[Patent document 3] Japanese Laid-open Patent Publication No. 2012-212956.

[Patent document 4] Japanese National Publication of International Patent Application No. 2013-516150.

[Patent document 5] Japanese National Publication of International Patent Application No. 2013-534763.

[Patent document 6] Japanese Laid-open Patent Publication No. 2013-102291.

As described above, the cooperative communication can improve the throughput of a terminal apparatus located at a cell edge.

However, when executing the cooperative communication, the plurality of base station apparatuses decide the application of the cooperative communication on the basis of each terminal apparatus located at the cell edge, and control and process for the execution. In this case, because the plurality of base station apparatuses execute the cooperative communication on the basis of each individual terminal apparatus, each processing load in the plurality of base station apparatuses increases as the number of terminal apparatuses located at cell edges increases.

In any technique mentioned above, the plurality of base station apparatuses execute cooperative communication on the basis of each individual terminal apparatus. Accordingly, in any of the above-mentioned techniques, each processing load in the base station apparatuses executing cooperative communication increases, as the number of terminal apparatuses located at cell edges increases.

### SUMMARY

According to an aspect of the embodiments, a base station apparatus that performs radio communication with a terminal apparatus, the base station apparatus including: a receiver configured to receive information from the terminal apparatus; and a processor configured to perform radio communication in cooperation with another base station apparatus based on the information, for a region in which the terminal apparatus is located.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a radio communication system.

FIG. 2 is a diagram illustrating a configuration example of a radio communication system.

FIG. 3 is a diagram illustrating a configuration example of a base station apparatus.

FIG. 4 is a diagram illustrating a configuration example of a terminal apparatus.

FIG. 5 is a diagram illustrating a configuration example of a control unit.

FIG. 6 is a diagram illustrating a configuration example of a QoE processing unit.

FIG. 7 is a diagram illustrating processing for collecting user data.

FIG. 8 is a diagram illustrating an example of processing for collecting user data.

FIG. 9 is a diagram illustrating an example of QoE calculation processing.

FIG. 10 is a diagram illustrating an example of a QoE decision rule.

FIG. 11 is a diagram illustrating an example of a knowledge DB.

FIG. 12 is a sequence diagram illustrating an operation example.

FIG. 13A is a diagram illustrating an example of a communication history, and FIG. 13B is a diagram illustrating an example of a mobility decision result.

FIG. 14 is a diagram illustrating an example of a sensor installed on a moving body.

FIG. 15 is a diagram illustrating an example of a travel route.

FIG. 16 is a diagram illustrating a configuration example of a sensor.

FIG. 17 is a sequence diagram illustrating an operation example.

FIG. 18A is a diagram illustrating an example of a vehicle, and FIG. 18B is a diagram illustrating an example of a sensor provided on a vehicle.

FIG. 19 is a diagram illustrating an example of processing for an initial DB.

FIG. 20 is a diagram illustrating an example of a decision rule for an initial DB.

FIG. 21 is a diagram illustrating a storage example of initial QoE.

FIG. 22A and FIG. 22B are flowcharts illustrating examples of data storage processing.

FIG. 23A and FIG. 23B are flowcharts illustrating examples of probability density distribution processing.

FIG. 24 is a flowchart illustrating an example of QoE calculation processing.

FIG. 25 is a flowchart illustrating an example of processing for QoE probability density distribution calculation.

FIG. 26 is a flowchart illustrating an example of QoE prediction processing.

FIG. 27 is a flowchart illustrating an example of processing when a service is used.

FIG. 28A and FIG. 28B are diagrams illustrating examples of areas in a radio communication system.

FIG. 29A is a diagram illustrating an area in a radio communication system, and FIG. 29B is a diagram illustrating an example of the area.

FIG. 30A is a diagram illustrating QoE in an area, and FIG. 30B is a diagram illustrating an example of a radio communication system to which the CB mode is applied.

FIG. 31A is a diagram illustrating QoE in an area, and FIG. 31B is an example of a radio communication system to which the CB mode is applied.

FIG. 32 is a flowchart illustrating an example of processing when the CB mode is applied.

FIG. 33A is a diagram illustrating an example of a terminal which travels in an area, and FIGS. 33B, 33C are diagrams illustrating each example of QoE in the area.

FIG. 34 is a flowchart illustrating an example of processing when the CS mode is applied.

FIG. 35A is a diagram illustrating QoE in an area, and FIG. 35B and FIG. 35C are diagrams illustrating examples of a radio communication system to which the JP mode (DPS scheme) is applied, respectively.

FIG. 36 is a diagram illustrating an example of a radio communication system to which the JP mode (JT scheme) is applied.

FIG. 37 is a flowchart illustrating an example of processing when the JP mode is applied.

FIG. 38 is a diagram illustrating a configuration example of a radio communication system.

FIG. 39 is a diagram illustrating a configuration example of a radio communication system.

FIG. 40 is a diagram illustrating an example of an area in a radio communication system.

FIG. 41A is a diagram illustrating an example of QoE in an area, and FIG. 41B is a diagram illustrating an example of a radio communication system to which beamforming is applied.

FIG. 42A is a diagram illustrating an example of QoE in an area, and FIG. 42B is a diagram illustrating an example of a radio communication system to which beamforming is applied.

FIG. 43A is a diagram illustrating an example when a terminal travels in an area, and FIG. 43B and FIG. 43C are diagrams illustrating examples of QoE in the area, respectively.

FIG. 44A is a diagram illustrating an example of QoE in an area, and FIG. 44B and FIG. 44C are diagrams illustrating each example of a radio communication system to which the JP mode (DPS scheme) is applied, respectively.

FIG. 45A and FIG. 45B are diagrams illustrating each example of a radio communication system to which the JP mode (JT scheme) is applied, respectively.

FIG. 46A is a diagram illustrating an example of QoE in an area, and FIG. 46B is a diagram illustrating an example of a radio communication system to which the JP mode (JT scheme) is applied.

### DESCRIPTION OF EMBODIMENTS

Hereinafter, the present embodiments will be described in detail by reference to the drawings.

### First Embodiment

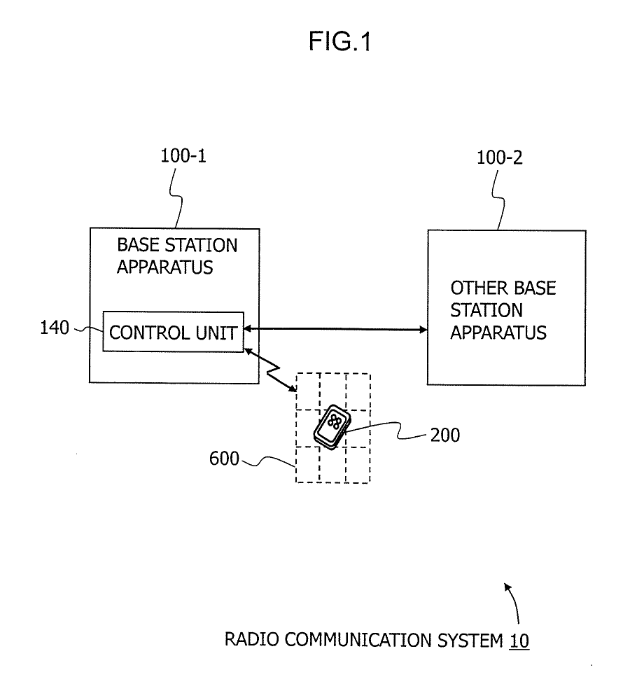

A first embodiment will be described below. FIG. 1 is a diagram illustrating a configuration example of a radio communication system 10 according to the first embodiment.

A radio communication system 10 includes a base station apparatus 100-1, another base station apparatus 100-2 and a terminal apparatus 200.

The base station apparatus 100-1 and the other base station apparatus 100-2 executes radio communication with the terminal apparatus 200. This enables the base station apparatus 100-1 and the other base station apparatus 100-2 to provide the terminal apparatus 200 with a variety of services including a speech communication service and a video delivery service.

Also, the base station apparatus 100-1 and the other base station apparatus 100-2 execute radio communication in a cooperative manner. The execution of radio communication by the two base station apparatuses 100-1, 100-2 in cooperation enables improving a throughput of the terminal apparatuses 200 located at a cell edge, for example.

The base station apparatus 100-1 includes a control unit 140. The control unit 140 executes radio communication targeted for a region 600, in which the terminal apparatus 200 is located, in cooperation with the other base station apparatus 100-2.

As such, the execution of radio communication targeted for the region 600 by the base station apparatus 100-1 in a cooperative manner with the other base station apparatus 100-2 enables the reduction of a processing load of the base station apparatus 100-1, in comparison with a case when radio communication is executed on the basis of each individual terminal 200.

For example, when the base station apparatus 100-1 executes cooperative radio communication for each individual terminal apparatus 200, the base station apparatus 100-1 executes the setting of beamforming etc. for each terminal apparatus 200, and exchanges a set setting value etc. with the other base station apparatus 100-2.

Meanwhile, according to the present first embodiment, the base station apparatus 100-1 executes radio communication targeted for the region 600 in a cooperative manner, and when executing the cooperative communication, for example, the base station apparatus 100-1 does not continuously execute the setting etc. for each individual terminal apparatus 200. This enables, for example, the reduction of a processing load in the base station apparatus 100-1, as well as a processing load in the other base station apparatus 100-2.

### Second Embodiment

Next, a second embodiment will be described. In the second embodiment, the description will be given in the following order.

<1. Configuration example of the radio communication system>

<2. Each configuration example of the base station and the terminal>

<3. Configuration example of the control unit in the base station>

<4. Operation example>

<1. Configuration Example of the Radio Communication System>

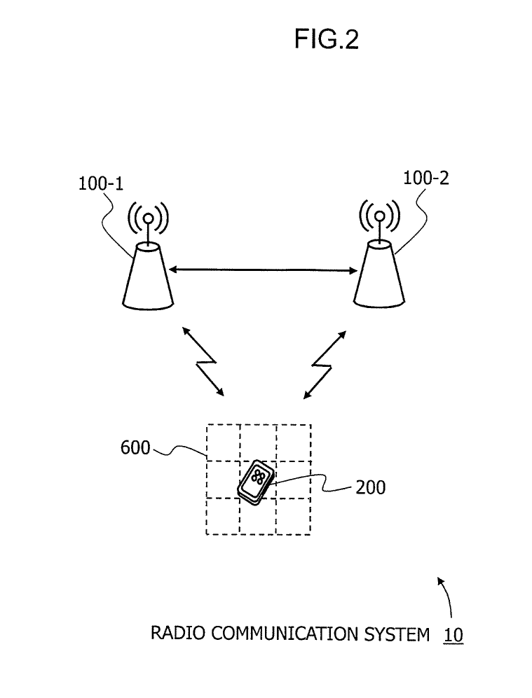

A configuration example of the radio communication system will be described. FIG. 2 is a diagram illustrating a configuration example of the radio communication system 10 according to the present second embodiment.

The radio communication system 10 includes a plurality of base station apparatuses (which may hereafter be referred to as “base stations”) 100-1, 100-2 and a terminal apparatus (which may hereafter be referred to as a “terminal”) 200.

Each base station apparatus 100-1, 100-2 is a radio communication apparatus executing radio communication with the terminal 200. Each base station 100-1, 100-2 can execute bidirectional communication with the terminal 200, in a communicable region of each self-station (which may be referred to as a “cell” or a “cell range”, and also, each base station 100-1, 100-2 may be referred to as a “cell”).

Namely, the bidirectional communication includes data transmission from each base station 100-1, 100-2 to the terminal 200 (or downlink communication) and data transmission from the terminal 200 to each base station 100-1, 100-2 (or uplink communication). Each base station 100-1, 100-2 performs scheduling etc. to allocate to the terminal 200 each radio resource (time resource and frequency resource, for example), to transmit the allocated radio resource to the terminal 200 as a control signal. Each base station 100-1, 100-2 and the terminal 200 executes downlink communication and uplink communication using the radio resource.

According to the present second embodiment, the plurality of base stations 100-1, 100-2 perform radio communication with the single terminal 200 in a cooperative manner. The execution of the radio communication with the terminal 200 in cooperation among the plurality of base stations 100-1, 100-2 may be referred to as Coordinated Multi-Point transmission and reception (which may hereafter be referred to as “cooperative communication” or “CoMP”), for example. The cooperative communication with, for example, a terminal 200 located at a cell edge by the plurality of base stations 100-1, 100-2 enables the improvement of the throughput of the terminal apparatus 200, so that improved communication performance can be attained.

Also, according to the present second embodiment, the plurality of base stations 100-1, 100-2 execute cooperative communication targeted for an area (or a region, which may hereafter be referred to as an “area”) 600. The execution of the cooperative communication targeted for the area 600, not for each individual terminal 200, by the plurality of base stations 100-1, 100-2 enables the reduction of a processing load as compared to a case when the cooperative communication is executed on the basis of each individual terminal 200, for example. The detail will be described later.

The area 600 is arranged in advance at each cell edge (or overlapped cell range) of the plurality of base stations 100-1, 100-2, for example. As depicted in FIG. 2, the area 600 may include a plurality of small areas, for example. In the figure, the small area is depicted to have a rectangular shape, but the shape thereof may be other polygonal shapes, such as a triangular shape, or a circular shape. Also, each small area may be of an identical or a different shape. In other words, there is no limited definition thereof, including an extent of the area. Additionally, the small area included in the area 600 may be referred to as area 600, or an overall area including the small area may be referred to as area 600.

In addition, the example depicted in FIG. 2 illustrates an example of two base stations 100-1, 100-2. However, it is possible that the radio communication system 10 includes three or more base stations if only can execute cooperative communication.

Further, as depicted in FIG. 2, the plurality of base stations 100-1, 100-2 are interconnected. This enables the plurality of base stations 100-1, 100-2 to exchange information related to the cooperative communication.

The terminal 200 is a radio communication apparatus such as a feature phone, a smart phone, a tablet and a personal computer. By radio communicating with each base station 100-1, 100-2, the terminal 200 can receive the provision of a variety of services including a voice communication service, video and voice content delivery services, etc.

Each base station 100-1, 100-2 is, for example, of an identical configuration, and therefore, may be referred to as a base station 100 unless otherwise noted.

<2. Each Configuration Example of the Base Station and the Terminal>

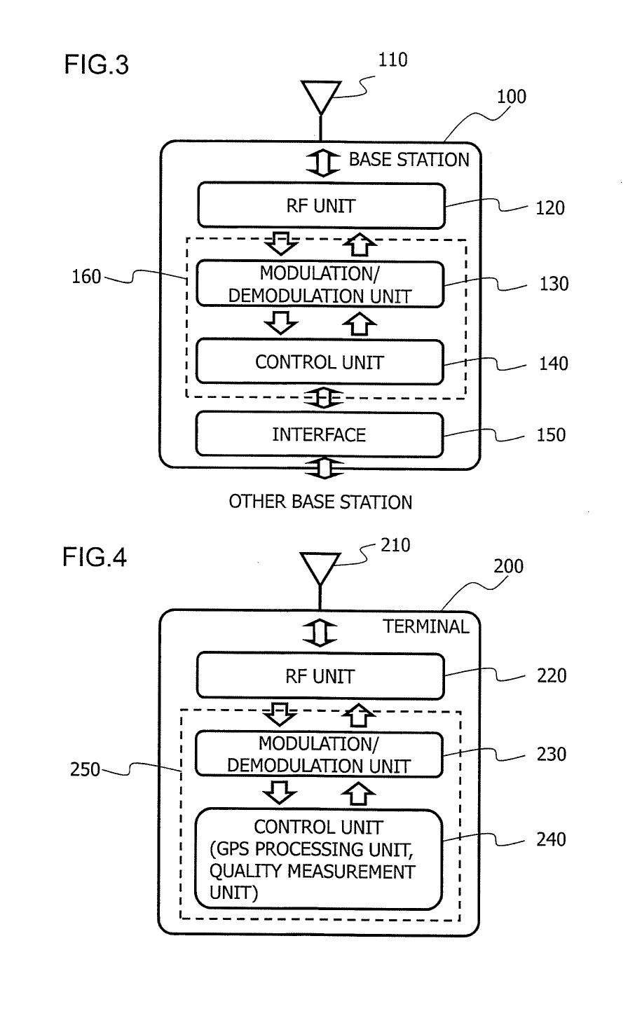

Next, each configuration example of the base station 100 and the terminal 200 will be described. FIG. 3 and FIG. 4 illustrate configuration examples of the base station 100 and the terminal 200, respectively.

The base station 100 includes an antenna 110, an RF (Radio Frequency) unit 120, a modulation/demodulation unit 130, a control unit 140 and an interface 150.

The antenna 110 transmits a radio signal, which is output from the RF unit 120, to the terminal 200 and also receives a radio signal transmitted from the terminal 200 to output to the RF unit 120.

The RF unit 120, on receiving a radio signal from the antenna 110, converts (downconverts) the radio signal in a radio band into a baseband signal, and then outputs the converted signal to the modulation/demodulation unit 130. Also, the RF unit 120 converts (upconverts) a signal output from the modulation/demodulation unit 130 into a radio signal, and then outputs the converted radio signal to the antenna 110. In order to perform such conversion processing, the RF unit 120 may internally include an AD (Analogue to Digital) conversion circuit, a frequency conversion circuit, etc. for example.

The modulation/demodulation unit 130 performs demodulation processing and error correction decoding processing on the signal which is output from the RF unit 120, to extract a message etc. transmitted from the terminal 200 to output to the control unit 140. Also, the modulation/demodulation unit 130 performs error correction coding processing and modulation processing on data etc. output from the control unit 140, to output to the RF unit 120 as a signal. In order to perform such conversion processing, error correction coding processing, etc., the modulation/demodulation unit 130 may internally include a modulation circuit, an error correction coding circuit, etc., for example.

The control unit 140 performs processing related to cooperative communication, for example. On receiving from the modulation/demodulation unit 130 a measurement report transmitted from the terminal 200, for example, the control unit 140 starts processing related to the cooperative communication. The detail of the processing related to the cooperative communication will be described later.

Further, the control unit 140 estimates (or calculates) quality of user experience (Quality of Experience: which may hereafter be referred to as “QoE”), for example. The QoE is an index value which indicates the degree of irritation a user feels at the use of a service content when the response thereof is delayed, for example. Or, the QoE is quality when the user at the use of a service content bodily feels on the content, for example. If a response delay is small, the QoE takes a satisfactory value, whereas if a response delay is large, the QoE takes an unsatisfactory value, for example. The control unit 140 predicts (or calculates) QoE for each area 600, for example, to perform cooperative communication based on the QoE. The detail of the QoE calculation will be described later.

Additionally, the control unit 140 performs overall control of the base station 100, so as to output data etc., which are output from the modulation/demodulation unit 130, to the interface 150, and outputs data etc. output from the interface 150 to the modulation/demodulation unit 130, for example.

The interface 150 is connected to another base station which executes cooperative communication. The interface 150 transmits, to the other base station, information related to the cooperative communication which is output from the control unit 140. In this case, the interface 150 converts the information concerned into the data having a transmittable format, so as to transmit to the other base station. Also, the interface 150 receives data related to the cooperative communication transmitted from another base station. In this case, the interface 150 extracts information related to the cooperative communication from the data concerned, to output to the control unit 140.

Here, as a hardware configuration, the base station 100 may include a CPU 160, the RF unit 120 and the interface 150. In this case, the modulation/demodulation unit 130 and the control unit 140 are included in the CPU 160.

Now, the terminal 200 includes an antenna 210, an RF unit 220, a modulation/demodulation unit 230 and a control unit 240.

The antenna 210 receives a radio signal which is transmitted from the base station 100, to output to the RF unit 220, and transmits to the base station 100 a radio signal output from the RF unit 220.

The RF unit 220, on receiving a radio signal from the antenna 210, converts (or downconverts) the radio signal in a radio band into a baseband signal, and then outputs the converted signal to the modulation/demodulation unit 230. Also, the RF unit 220 converts (or upconverts) a signal which is output from the modulation/demodulation unit 230 into a radio signal of a radio band. In order to perform such conversion processing, the RF unit 220 may internally include an AD conversion circuit, a frequency conversion circuit, etc., for example.

The modulation/demodulation unit 230 performs demodulation processing, error correction decoding processing, etc. on a signal output from the RF unit 220, to extract data etc. to output to the control unit 240. Also, the modulation/demodulation unit 230 performs error correction coding processing and modulation processing on data etc. which are output from the control unit 240, to output to the RF unit 220 as a signal. In order to perform such modulation processing, error correction coding processing, etc., the modulation/demodulation unit 230 may internally include a modulation circuit, an error correction coding circuit, etc., for example.

The control unit 240 measures the reception quality of a radio signal received in the terminal 200, for example. In this case, the control unit 240 may measure the reception quality of the signal which is output from the RF unit 220, or may measure the reception quality of the data output from the modulation/demodulation unit 230. The control unit 240 generates a measurement report which includes the measured reception quality, to transmit through the modulation/demodulation unit 230 etc. to the base station 100.

Further, the control unit 240 measures the position of the terminal 200 using the GPS (Global Positioning System) etc., to generate position information which indicates the present position of the terminal 200. For example, the position information indicates the position of the terminal 200 at a time point when the reception quality is measured. The control unit 240 may include the generated position information in the measurement report.

Further, it is also possible for the control unit 240 to measure a reception quality measurement time using an internal timer etc., so as to include the measurement time into the measurement report.

Further, the control unit 240 generates a variety of messages in response to a user operation on the terminal 200, to transmit to the base station 100 through the modulation/demodulation unit 230 etc., for example.

Here, as a hardware configuration, the terminal 200 may include a CPU 250 and the RF unit 220. In this case, the modulation/demodulation unit 230 and the control unit 240 are included in the CPU 250.

<3. Configuration Example of the Control Unit in the Base Station>

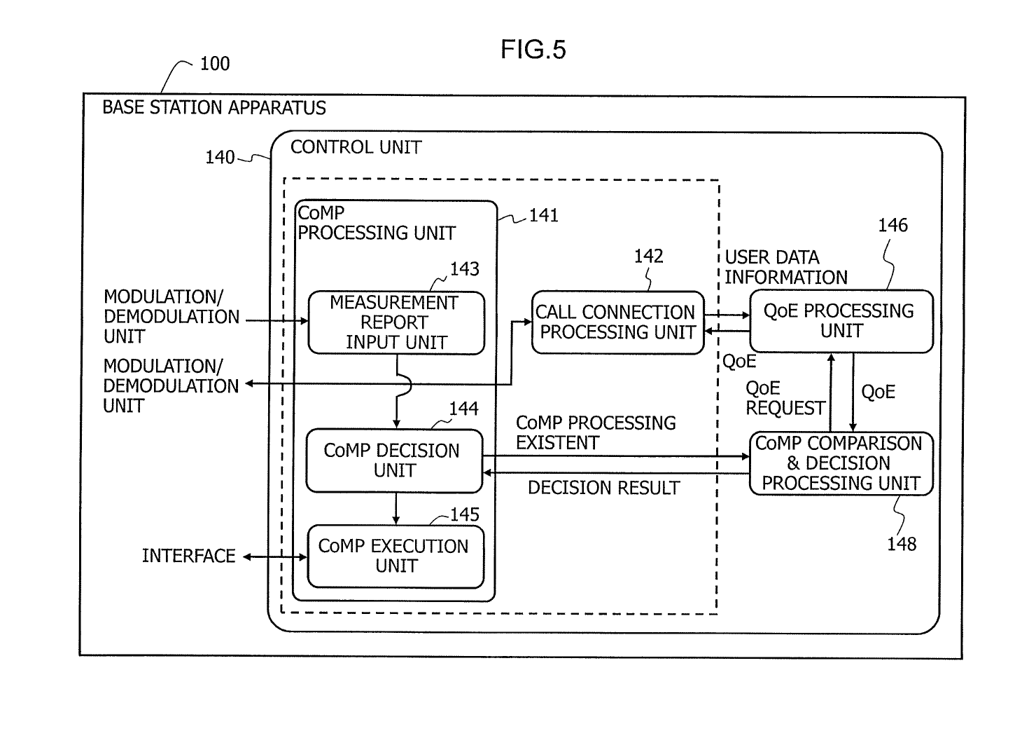

Next, a description will be given on a configuration example of the control unit 140 in the base station 100. FIG. 5 is a diagram illustrating a configuration example of the control unit 140. The control unit 140 includes a CoMP processing unit 141, a call connection processing unit 142, a QoE processing unit 146 and a CoMP comparison & decision processing unit 148.

The CoMP processing unit 141, triggered by the reception of the measurement report transmitted from the terminal 200, for example, decides whether or not to execute cooperative communication targeted for the area 600. On deciding to execute the cooperative communication, the CoMP processing unit 141 executes the cooperative communication targeted for the area 600. The CoMP processing unit 141 includes a measurement report input unit 143, a CoMP decision unit 144 and a CoMP execution unit 145.

The measurement report input unit 143 extracts a measurement report from among data which are output from the modulation/demodulation unit 130. From the extracted measurement report, the measurement report input unit 143 extracts quality information, position information, time information, etc., and outputs the extracted quality information etc. to the CoMP decision unit 144. In this case, the measurement report input unit 143 may directly output, to the QoE processing unit 146, the position information and the time information out of the extracted information.

For example, based on identification information included in data etc. which are output from the modulation/demodulation unit 130, the measurement report input unit 143 extracts a measurement report out of data which are output from the modulation/demodulation unit 130.

The CoMP decision unit 144 decides whether or not to execute cooperative communication on the basis of the quality information received from the measurement report input unit 143. For example, the quality information includes radio quality in a radio section between the terminal 200 and each base station 100-1, 100-2.

For example, the following decision is made. Namely, if both radio quality between the terminal 200 and the base station 100-1 and radio quality between the terminal 200 and the base station 100-2 equals a decision threshold for cooperative communication or lower, the CoMP decision unit 144 decides that cooperative communication is to be executed. On the other hand, if either one of the radio quality exceeds the cooperative communication decision threshold, or if both of the radio quality exceed the cooperative communication decision threshold, the CoMP decision unit 144 decides that cooperative communication is not to be executed. This enables each base station 100-1, 100-2 to discriminate that the terminal 200 is located in the overlapped cell range of the plurality of base stations 100-1, 100-2.

When deciding that cooperative communication is to be executed, the CoMP decision unit 144 outputs information which indicates to that effect (information indicative of “CoMP processing existent” in the example of FIG. 5) to the CoMP comparison & decision processing unit 148. When deciding that cooperative communication is not to be executed, the CoMP decision unit 144 outputs no particular information to the CoMP comparison & decision processing unit 148 and the CoMP execution unit 145, for example.

Further, the CoMP decision unit 144 receives from the CoMP comparison & decision processing unit 148 the decision result including whether or not to execute cooperative communication targeted for the area 600. For example, when obtaining a decision result indicating that cooperative communication targeted for the area 600 is to be executed, the CoMP decision unit 144 instructs to execute cooperative communication targeted for the area 600. On the other hand, when obtaining a decision result indicating that cooperative communication targeted for the area 600 is not to be executed, the CoMP decision unit 144 instructs to execute cooperative communication targeted for the terminal 200 (which may hereafter be referred to as “ordinary cooperative communication”).

The CoMP execution unit 145, on receiving an instruction to execute cooperative communication targeted for the area 600, executes the cooperative communication targeted for the area 600.

For example, the following processing is executed. Namely, the CoMP execution unit 145 generates a set value related to the cooperative communication targeted for the area 600, to exchange the generated set value between with the other base station through the interface 150. Then, according to the set value, the CoMP execution unit 145 controls (or does not control) the antenna 110 to transmit a radio signal to the area 600, and performs processing to allocate (or not to allocate) a radio resource to a terminal 200 which travels to a travel destination area 600 after the lapse of a predetermined time, and so on.

Further, on receiving an instruction to execute ordinary cooperative communication, the CoMP execution unit 145 executes the cooperative communication targeted for the terminal 200.

For example, the following processing is executed. Namely, the CoMP execution unit 145 generates a set value related to the ordinary cooperative communication, to exchange the generated set value between with the other base station through the interface 150. Then, the CoMP execution unit 145 controls (or does not control) the antenna 110 to transmit a radio signal to the terminal 200, and performs processing to allocate (or not to allocate) a radio resource to the terminal 200.

There are a few schemes for cooperative communication. For example, there are a Coordinated Beamforming (which may hereafter be referred to as “CB”/Coordinated Scheduling (which may hereafter be referred to as “CS”) scheme and a Joint Processing (which may hereafter be referred to as “JP”) scheme.

The CB/CS scheme includes a CB scheme and a CS scheme. According to the CB/CS scheme, data transmission is performed from one base station 100-1, whereas the determination of beamforming and scheduling is made by the plurality of base stations 100-1, 100-2 in a cooperative manner.

In contrast, according to the JP scheme, for example, data is transmitted from the plurality of base stations 100-1, 100-2 to the terminal 200. The JP scheme includes a JT (Joint Transmission; which may hereafter be referred to as “JT”) scheme and a DPS (Dynamic Point Selection; which may hereafter be referred to as “DPS”) scheme. According to the JT scheme, for example, data is simultaneously transmitted from the plurality of base stations 100-1, 100-2. On the other hand, according to the DPS scheme, data is transmitted from one base station 100-1 when viewed momentarily.

In the following, each scheme related to the cooperative communication may be referred to as mode. Here, the JT mode may be referred to as “JP mode JT”, and the DPS mode may be referred to as “JP mode DPS”.

The call connection processing unit 142 performs call connection control and call management for the terminal 200. For example, there is processing as follows. Namely, on receiving from the modulation/demodulation unit 130 a message etc. transmitted from the terminal 200, the call connection processing unit 142 extracts user data information etc. included in the message, to output to the QoE processing unit 146. Also, on receiving QoE from the QoE processing unit 146, the call connection processing unit 142 transmits the received QoE through the modulation/demodulation unit 130 etc. to the terminal 200.

Here, the user data information is, for example, information for use for QoE calculation in the QoE processing unit 146. The detail of the user data information will be described later.

The QoE processing unit 146 calculates QoE on the basis of the user data information, and outputs the calculated QoE to the call connection processing unit 142. Also, on receiving a QoE request from the CoMP comparison & decision processing unit 148, the QoE processing unit 146 outputs QoE responding to the QoE request to the CoMP comparison & decision processing unit 148. In the QoE request, for example, information related to the area 600 is included, so that QoE related to the area 600 concerned is output. The detail of the QoE processing unit 146 will be described later.

On receiving from the CoMP decision unit 144 a decision result to the effect that the cooperative communication is to be executed, the CoMP comparison & decision processing unit 148 decides the mobility of the terminal 200 in the area 600, and according to the decision result, discriminates one of the cooperative communication modes to be applied to. Then, in the applied mode, the CoMP comparison & decision processing unit 148 decides whether or not to execute the cooperative communication targeted for the area 600 according to the QoE. The CoMP comparison & decision processing unit 148 outputs the decision result to the CoMP decision unit 144. The detail of the processing performed in the CoMP comparison & decision processing unit 148 will be described later.

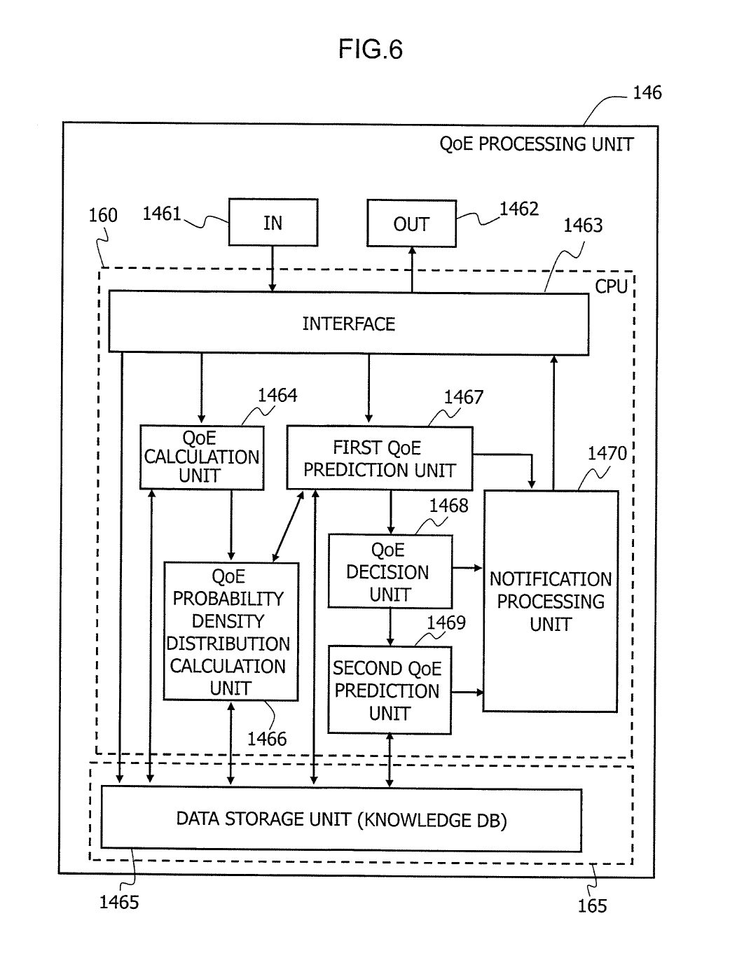

Next, a configuration example of the QoE processing unit 146 will be described. FIG. 6 is a diagram illustrating a configuration example of the QoE processing unit 146. The QoE processing unit 146 includes an input unit (IN) 1461, an output unit (OUT) 1462, an interface 1463, a QoE calculation unit 1464, a data storage unit 1465, a QoE probability density distribution calculation unit 1466, a first QoE prediction unit 1467, a QoE decision unit 1468, a second QoE prediction unit 1469 and a notification processing unit 1470.

The input unit 1461, on receiving user data information and a QoE request output from the call connection processing unit 142, outputs the user data information and the QoE request to the interface 1463.

The output unit 1462 outputs the QoE, received from the interface 1463, to the call connection processing unit 142 and the CoMP comparison & decision processing unit 148.

The interface 1463, on receiving the user data information etc. from the input unit 1461, outputs the user data information etc. to the data storage unit 1465 and the QoE calculation unit 1464. Also, the interface 1463 outputs QoE received from the notification processing unit 1470 to the output unit 1462.

The QoE calculation unit 1464 estimates (or calculates) QoE. For example, the QoE calculation unit 1464 calculates QoE on the basis of a time (or a delay time amount) consumed after the terminal 200 requests a service content and before the delivery of the service content is started, and a traffic amount at that time. Other than the delay time amount and the traffic amount, the QoE may be calculated using a user throughput, a traffic amount, a combination of the user throughput with the traffic amount, and further, a combination of other indexes including a buffer use rate, a packet loss rate, etc. The detail of the QoE calculation will be described later. The QoE calculation unit 1464 stores the calculated QoE into the data storage unit 1465, and outputs the QoE to the QoE probability density distribution calculation unit 1466.

The data storage unit 1465 stores the position information, the time information and the traffic amount of the terminal 200, which are for use for the QoE calculation, and the calculation result of the calculated QoE. Here, the data storage unit 1465 includes a knowledge DB to store the position information, the time information, the traffic amount, the QoE, etc. Hereafter, the data storage unit 1465 may be referred to as knowledge DB (Data Base) 1465, for example. Though the detail of the knowledge DB 1465 will be described later, for example, an example thereof is depicted in FIG. 11.

The QoE probability density distribution calculation unit 1466 calculates QoE in each area 600 at each predetermined time interval, for example.

For example, in regard to the area 600, a square range is defined to be one area. If the set value of one side is 250 meters, a 250-meter square is defined to be one area. For example, the QoE calculation unit 1464 calculates QoE in a certain position at a certain moment, whereas the QoE probability density distribution calculation unit 1466 calculates the probability density distribution of QoE in each group on the basis of one or a plurality of sets of QoE in a predetermined group, to calculate a representative value of the QoE in each group. Here, as to the group, a data set which satisfies to be within a combination range of “area” and “time information (or set time interval)” among the stored data is classified into one group, for example. The detail of the QoE calculation etc. will be described later. The QoE probability density distribution calculation unit 1466 stores the calculated probability density distribution and the QoE representative value into the knowledge DB 1465, and also outputs to the first QoE prediction unit 1467.

The first QoE prediction unit 1467, when the terminal 200 requests the use of a service content for example, predicts QoE which is assumed at a position and a time of the request, on the basis of probability density distribution information. The detail thereof will be described later. The first QoE prediction unit 1467 outputs the predicted QoE to the QoE decision unit 1468 and the notification processing unit 1470.

The QoE decision unit 1468 receives the predicted QoE from the first QoE prediction unit 1467, for example, to decide whether or not the QoE concerned is deteriorated. For example, the QoE decision unit 1468 compares the QoE concerned with a decision threshold, to decide that the QoE is deteriorated if the QoE is smaller than the decision threshold, or the QoE is satisfactory if otherwise. When deciding that the QoE is deteriorated, the QoE decision unit 1468 instructs the second QoE prediction unit 1469 to estimate the time when the QoE becomes satisfactory. On the other hand, when deciding that the QoE is satisfactory, the QoE decision unit 1468 instructs the notification processing unit 1470 to start a service. With this, for example, the base station 100 instructs a content server etc. to start the service.

According to the instruction from the QoE decision unit 1468, the second QoE prediction unit 1469 calculates the time when the QoE becomes satisfactory, on the basis of the probability density distribution information calculated by the first QoE prediction unit 1467. A detailed calculation scheme will be described later. The second QoE prediction unit 1469 instructs the notification processing unit 1470 to transmit the calculated predicted time to the terminal 200 which requests the use of the service content, for example.

The notification processing unit 1470 outputs the QoE, received from the first QoE prediction unit 1467, to the interface 1463. This causes the output of the QoE to the call connection processing unit 142 and the CoMP comparison & decision processing unit 148, for example.

Further, according to the instruction from the QoE decision unit 1468 for example, the notification processing unit 1470 generates a message to request to deliver the service content. Also, according to the instruction from the second QoE prediction unit 1469, the notification processing unit 1470 generates a message to transmit the predicted time to the terminal 200. The notification processing unit 1470 outputs the generated message to the interface 1463. Such a message etc. are transmitted, for example, through the call connection processing unit 142 to the terminal 200.

Here, as hardware, the QoE processing unit 146 may include an input unit 1461, an output unit 1462, a CPU 160 and a memory 165. In that case, the CPU 160 includes the interface 1463, the QoE calculation unit 1464, the QoE probability density distribution calculation unit 1466, the first QoE prediction unit 1467, the QoE decision unit 1468, the second QoE prediction unit 1469 and the notification processing unit 1470.

<4. Operation Example>

Next, an operation example of the radio communication system 10 will be described. The description of the present operation example will be given in the following order. In the present second embodiment, there is performed CoMP control for an area in which each terminal 200 is located. However, for the sake of convenience, the description will be given as an operation example based on the behavior of a single terminal 200.

<4.1 Operation example of QoE calculation>

<4.2 Overall operation example>

<4.3 Initial value registration to the knowledge DB>

<4.4 Each processing flow for QoE calculation processing etc.>

<4.5 Example of area>

<4.6 CB mode operation example>

<4.7 CS mode operation example>

<4.8 JP mode operation example>

<4.9 Example of smart meter system>

<4.10 Example of HetNet>

The base station 100 performs operation as described below, for example. Namely, the base station 100 first calculates QoE. Thereafter, triggered by the reception of a measurement report transmitted from the terminal 200, the base station 100 decides whether or not to execute ordinary cooperative communication. When deciding to execute the ordinary cooperative communication, the base station 100 further decides whether or not to execute cooperative communication targeted for the area 600.

In the operation example described below, first, the operation example of QoE calculation will be described in <4.1 Operation example of QoE calculation> through <4.4 Each processing flow for QoE calculation processing etc.>. Also, an overall operation example of the radio communication system 10 will be described in <4.2 Overall operation example>.

Next, an example of the area 600 will be described in <4.5 Example of area>. Further, in regard to how the cooperative communication targeted for the area 600 is to be executed, which includes decision on whether or not to execute the ordinary cooperative communication, decision on whether or not to execute the cooperative communication targeted for the area 600, etc., description will be given in <4.6 CB mode operation example> through <4.8 JP mode operation example>.

Finally, each example for cases when the present invention is applied to a smart meter system and a HetNet (Heterogeneous Network) will be described in <4.9 Example of smart meter system> and <4.10 Example of HetNet>.

<4.1 Operation Example of QoE Calculation>

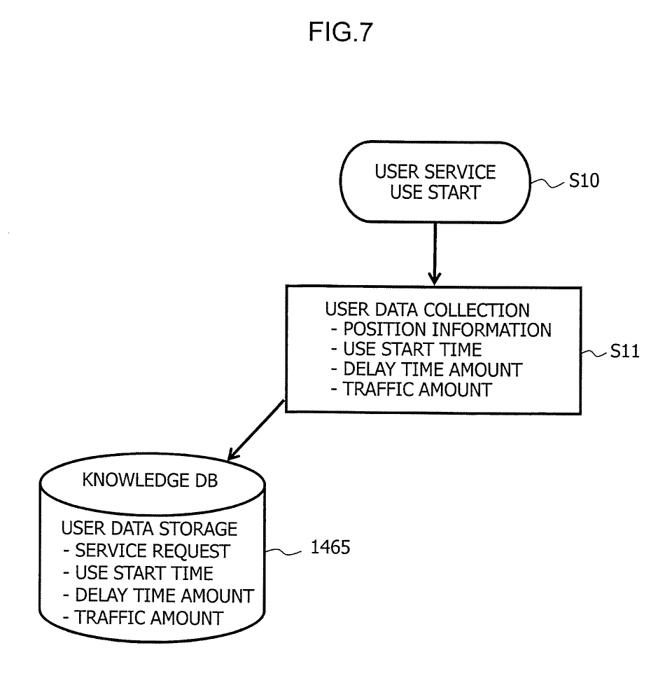

The operation example of QoE calculation is described. FIGS. 7 through 11 are diagrams for describing the operation example of the QoE calculation.

As to the sequence of the QoE calculation, first, the QoE processing unit 146 in the base station 100 collects user data information to store into the knowledge DB 1465. Next, the QoE processing unit 146 calculates QoE on the basis of the collected user data information.

First, each operation example of collection processing of user data information and storage processing into the knowledge DB 1465 will be described.

<4.1.1 User Data Collection Processing and Storage Processing to the Knowledge DB>

FIG. 7 is a flowchart illustrating collection processing of user data information and storage processing into the knowledge DB 1465.

The terminal 200, on starting to use a user service (S10), the base station 100 collects user data information (S11). The user data information includes, for example, position information of the terminal 200, a use start time, a delay time amount, a traffic amount, etc. The base station 100 stores the collected user data information into the knowledge DB 1465.

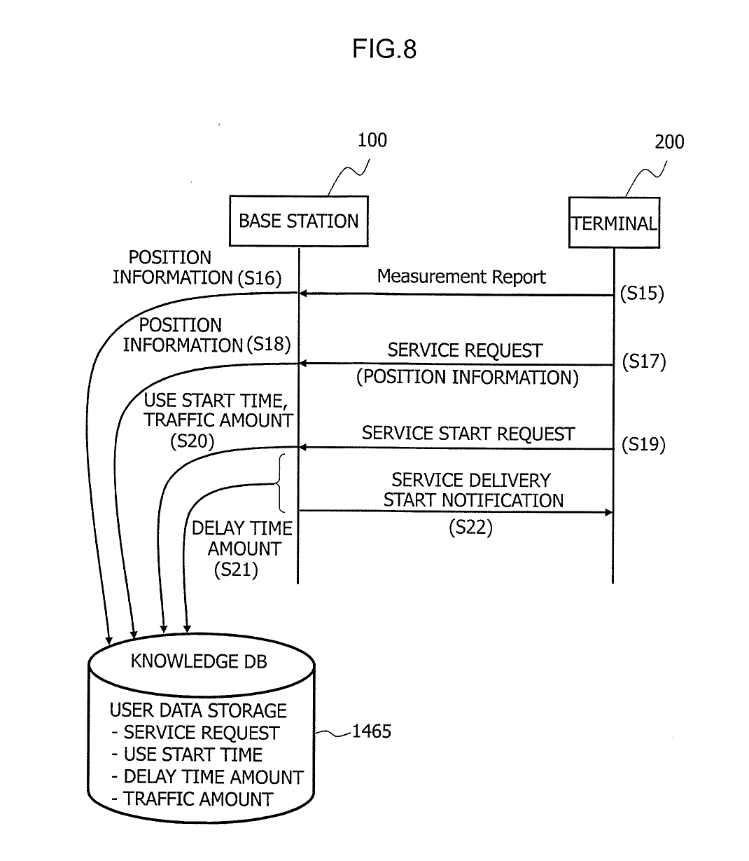

FIG. 8 is a diagram illustrating how the position information, the use start time and the delay time amount are stored into the knowledge DB 1465.

The terminal 200 transmits a measurement report when locating, for example, in the overlapped cell range of a plurality of base stations 100-1, 100-2 (S15). For example, the terminal 200 acquires the position information using the GPS, to transmit the measurement report including the acquired position information.

Next, the terminal 200, on starting to use the user service, transmits a service request message (S17). The service request message is a message for requesting the use of a content service, for example. In this case also, the terminal 200 acquires the position information using the GPS, to transmit the service request message including the acquired position information.

The base station 100, on receiving the measurement report and the service request, extracts position information included in these messages, to store into the knowledge DB 1465 (S16, S18).

Here, as user data information, instead of using both of the position information stored in the measurement report and the service request message, the base station 100 may use either one of the position information.

The terminal 200, after the start of using the user service, transmits a service start request to request to start the service (S19). The service start request is a message, triggered by the user operation of the terminal 200 etc., which is transmitted at a request for actually starting the service, such as a request for content delivery.

The base station 100 stores the reception time of the service start request into the knowledge DB 1465, as a use start time, for example (S20). Further, on receiving the service start request, the base station 100 increments the reception count of the message stored in the knowledge DB 1465. The incremented count value becomes a traffic amount, for example.

For example, the following processing is carried out. Namely, the call connection processing unit 142 in the base station 100, on receiving the service start request, outputs the request concerned to the interface 1463 of the QoE processing unit 146. The interface 1463 measures the reception time of the request and counts up the reception count of the request, so as to output the reception time and the count value to the knowledge DB 1465. Thus, the reception time and the traffic amount are stored into the knowledge DB 1465.

Here, in place of the interface 1463, the call connection processing unit 142 may execute such processing. The call connection processing unit 142 also transmits a service use start request to a content server etc.

Next, the base station 100 transmits a service delivery start notification to the terminal 200 (S22). The service delivery start notification is a message transmitted from the content server etc. before the start of the service, for example. After the transmission of the above message, for example, user data etc. related to the content are transmitted.

In this case, the base station 100, after receiving the service start request (S20), measures a time consumed before starting the transmission of the service delivery start notification message (or service start notification message) (S22) (or a time when the content service delivery is actually started). The base station 100 transacts the measured time to be a delay time amount, to store into the knowledge DB 1465.

For example, the following processing is carried out. Namely, the call connection processing unit 142, on receiving the service start request (S20) and the service delivery start notification (S22), outputs the above request and the notification to the interface 1463 of the QoE processing unit 146. The interface 1463, after receiving the service start request, measures a time consumed before receiving the service delivery start notification, as a delay time amount. The interface 1463 stores the measured delay time amount into the knowledge DB 1465.

In the example depicted in FIG. 8, it is exemplified when the service request (S17) and the service start request (S19) are made separately. However, it may also be possible to include the service start request (S19) in the service request (S17). In that case, the base station 100 transacts the reception time of the service request (S17) to be the use start time, and also the request reception count to be a traffic amount, so as to store into the knowledge DB 1465. Also, the base station 100 calculates a time consumed after receiving the service request (S17) and before transmitting the service delivery start notification (S22), as a delay time amount, so as to store the delay time amount into the knowledge DB 1465.

<4.1.2 QoE Calculation Processing>

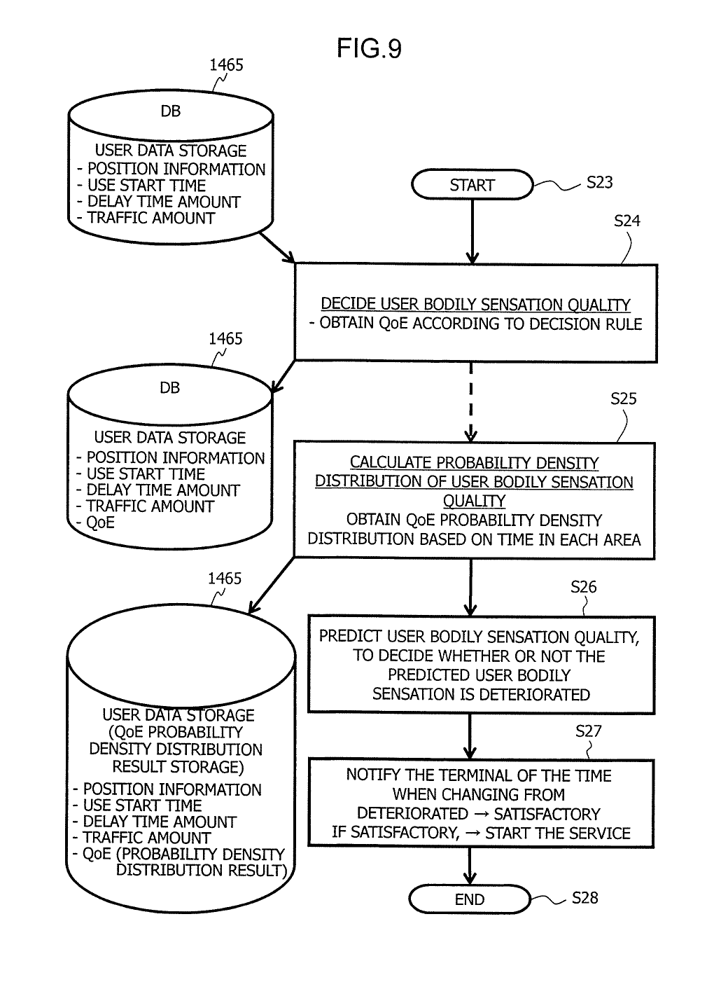

Next, QoE calculation processing will be described. FIG. 9 is a flowchart illustrating an operation example of the QoE calculation processing.

The base station 100, on starting the QoE calculation processing (S23), calculates QoE on the basis of the user data information stored in the knowledge DB 1465 (S24). For example, the QoE calculation unit 1464 calculates the QoE on the basis of the stored user data information according to a decision regulation (or decision rule).

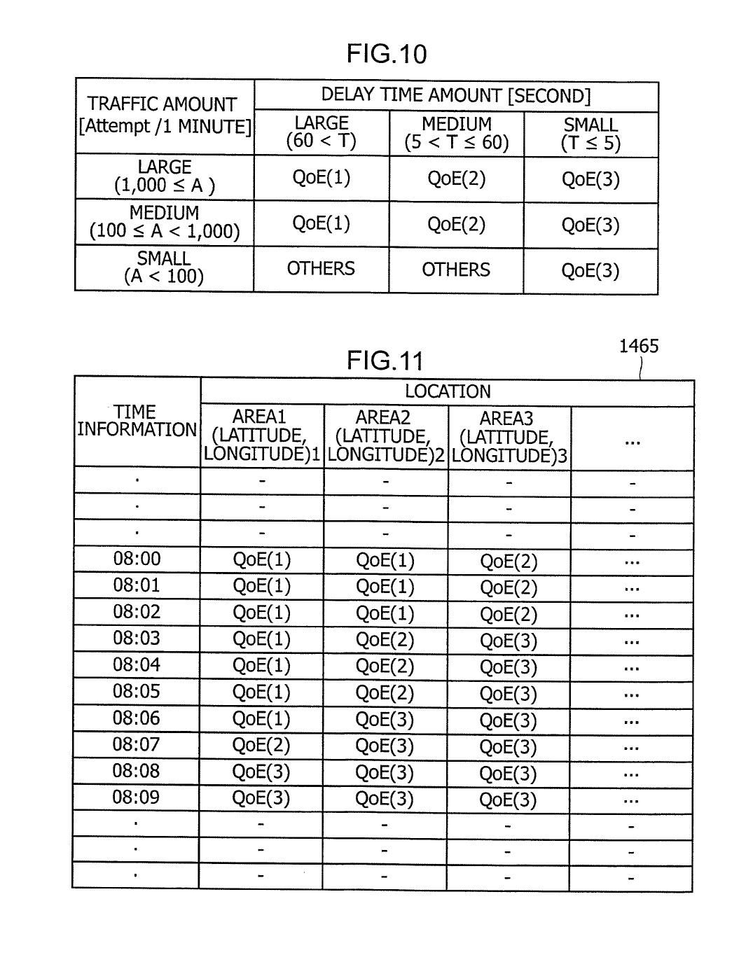

FIG. 10 is a diagram illustrating an example of the decision rule. In FIG. 10, there is illustrated an example that the QoE is decided based on a traffic amount and a delay time among the collected user data information.

Namely, let a traffic amount be “A” and a delay time amount be “T”, then, by the comparison with thresholds (“100” and “1000”), the traffic amount A is decided to be “large” (if A≧1000), “middle” (100≦A<1000) or “small” (A<100). Also, the delay time amount T is decided to be “large” (60<T), “middle” (5<T≦60) or “small” (T≦5).

Based on each combination of “large”, “middle” or “small” of the traffic amount and “large”, “middle” or “small” of the delay time amount, “QoE(1)”, “QoE(2)” or “QoE(3)” is calculated as QoE. Here, among the “QoE(1)” through the “QoE(3)”, it is assumed that the “QoE(3)” is the most satisfactory QoE, whereas the “QoE(1)” is the least satisfactory. For example, the QoE calculation unit 1464 stores the calculated QoE in combination with the position information and the use start time, into the knowledge DB 1465.

Here, in FIG. 10, “others” signify a case when, in spite that the traffic amount is smaller than the thresholds, the delay time amount is larger than the thresholds, which is considered to be influenced by another factor, so that QoE in such a case is excluded.

Further, the thresholds for the traffic amount (“100” and “1000”), the thresholds for the delay time amount (“5” and “60”), etc. can appropriately be changed by the QoE calculation unit 1464, for example. Also, the number of thresholds is appropriately changeable. Moreover, such QoE calculation may be executed either at the time point when the user data information is collected or after the user data information is stored.

Referring back to FIG. 9, after the QoE calculation (S24), the base station 100 calculates QoE probability density distribution on the QoE of each area 600 for each predetermined time interval, to calculate the representative value of QoE in each area 600 (S25).

The calculation of the QoE representative value is carried out in the following manner, for example. Namely, first, the service coverage of the base station 100 is sectioned into each predetermined unit of area 600 (for example, an area of 250 meter square). Then, in each sectioned area 600, the calculation of the probability density distribution and the calculation of the QoE representative value are executed on the basis of each predetermined time interval.

For example, when an area set value is “250 meters” and a predetermined time interval is “1 minute”, for the QoE calculated according to the decision rule (FIG. 10), the base station 100, using the position information which is stored in combination with the calculated QoE, acquires an area 600 to which the position information belongs, and extracts from the knowledge DB 1465 the past QoE in the area 600 concerned. Then, for example, the base station 100 groups the QoE calculated by the decision rule and the extracted QoE in time series (for example, group on the basis of every one minute), and obtains the probability density distribution for each group, to store into the knowledge DB 1465 the QoE having the highest probability density, as a QoE representative value in the group concerned.

Such processing is carried out on the basis of the QoE which the QoE probability density distribution calculation unit 1466 receives from the QoE calculation unit 1464, and the QoE which is read out from the knowledge DB 1465. The QoE probability density distribution calculation unit 1466 then stores into the knowledge DB 1465 the calculated probability density distribution and the QoE representative value of each group, to output to the first QoE prediction unit 1467.

FIG. 11 is a diagram illustrating an example of the knowledge DB stored in such a manner. In the example of FIG. 11, the area 600 is sectioned into “area 1”, “area 2”, “area 3”, . . . , and for each area 600, QoE having the highest probability density at each predetermined time interval (“one minute”) in a time duration from “8:00” to “8:01” etc. is already stored. For example, it is assumed that in the “area 1”, three sets of QoE, i.e. “QoE(1)”, “QoE(2)” and “QoE(3)” have been calculated for the time duration from “8:00” to “8:01”. In this case, QoE having the highest probability density corresponds to the QoE of a largest calculated count (for example, “QoE(1)”) among three sets of QoE.

Additionally, in the example of FIG. 11, additional information such as day of the week, public holiday, presence or non-presence of a held event may be stored in the knowledge DB 1465, for example. It may also be possible to exclude QoE indicative of a different traffic state from a normal time, such as at the occurrence of an event and an accident for example, from the knowledge DB 1465. The base station 100 can appropriately set such additional information.

Referring back to FIG. 9, a supervision control apparatus 300, after the calculation of the probability density distribution and the QoE (S25), predicts a time point when the user receives the service content delivery, and QoE in an area 600 to which the terminal 200 travels after a predetermined time, on the basis of the QoE stored in the knowledge DB 1465 (S26).

The prediction of QoE is carried out in the following manner, for example. Namely, the base station 100, on receiving from the terminal 200 a measurement report (for example, S15 in FIG. 8) and a service request (for example, S17 in FIG. 8), determines a corresponding “area” on the basis of the position information included in the message etc. Also, based on the time included in these messages or each reception time of these messages, the base station 100 determines a “target time”. The base station 100 then extracts QoE corresponding to the determined “area” and the “target time” from the knowledge DB 1465.

For example, if position information (for example, longitude and latitude information) included in the service request message corresponds to “area 2” and the reception time is “8:00:30 am”, then, from the knowledge DB 1465, “08:00” as “time information” and “QoE(1)” corresponding to “area 2” are extracted.

Next, for example, the base station 100 compares the predicted QoE with a threshold, to decide whether or not the QoE deviates from a predefined tolerable range of quality (S26). For example, when deciding there is no deviation, the base station 100 starts to provide a service. Also, when deciding there is deviation, the base station 100 calculates a predicted time when the predicted QoE becomes satisfactory, on the basis of the knowledge DB 1465, to notify the terminal 200 (S27). On completion of processing executed after the decision on the predicted QoE (S27), the base station 100 completes a series of processing (S28).

<4.2 Overall Operation Example>

Next, an operation example of the overall radio communication system 10 will be described. It is assumed that, in the base station 100, QoE is already stored in the knowledge DB 1465 through the above-mentioned QoE calculation processing.

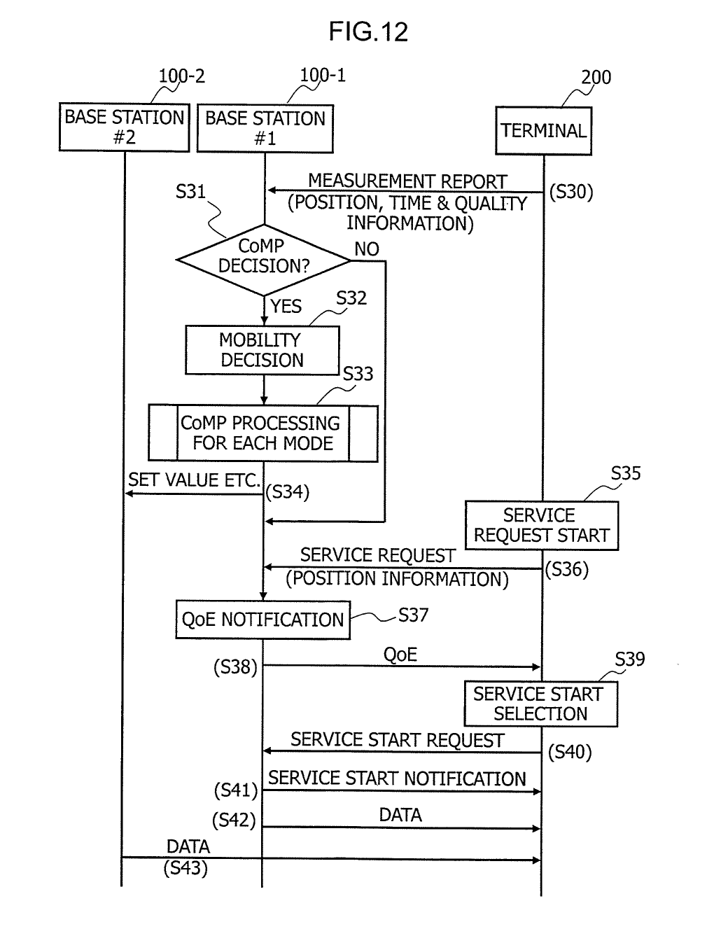

FIG. 12 is a sequence diagram illustrating an operation example in the radio communication system 10. The example of FIG. 12 illustrates a case that the terminal 200 is radio connected to the base station 100-1 and has traveled into a mutually overlapped cell range of the two base stations 100-1, 100-2.

The terminal 200, when traveling into the overlapped cell range, transmits a measurement report to the base station 100-1 (S30). The measurement report includes the position information, the quality measurement time and the quality information of the terminal 200, for example.

The base station 100-1, triggered by the reception of the measurement report, decides whether or not to execute cooperative communication targeted for the area 600 (S31-S34).

Namely, the base station 100-1 decides whether or not to execute ordinary cooperative communication on the basis of the quality information included in the measurement report (S31). On deciding not to execute the ordinary cooperative communication (N in S31), the base station 100-1 shifts to the processing of S37, without executing processing related to the ordinary cooperative communication. In this case, the base station 100-1 transmits data toward the terminal 200 without executing the cooperative communication together with the base station 100-2 (S42), causing no data transmission from the base station 100-2. The decision of whether or not to execute the ordinary cooperative communication is made in the CoMP decision unit 144 of the base station 100-1, for example.

On the other hand, on deciding to execute the ordinary cooperative communication (Y in S31), the base station 100-1 decides the mobility of the area 600 in which the terminal 200 is located (S32).

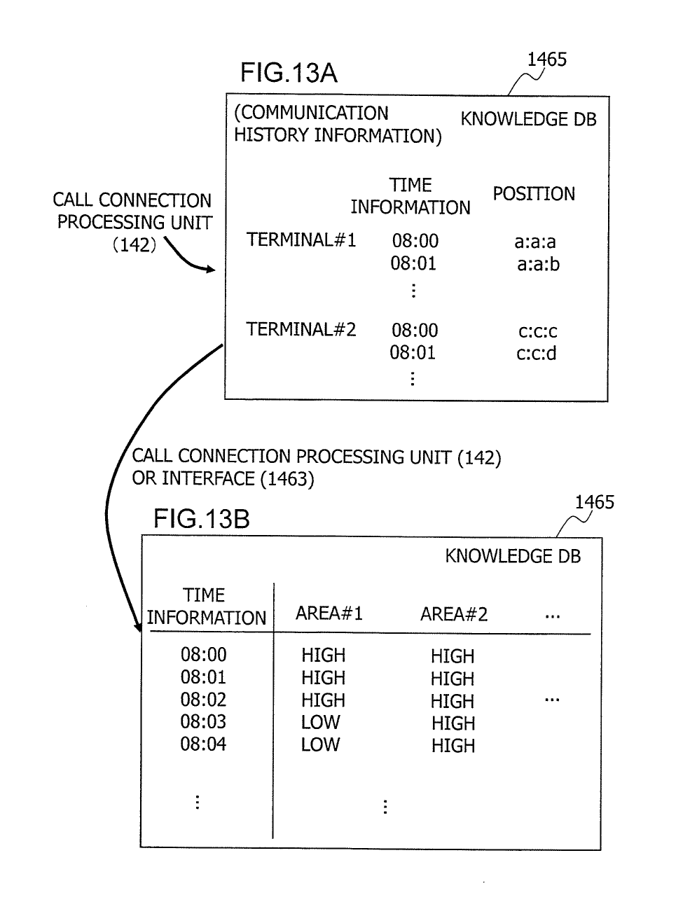

The decision of mobility is carried out in the following manner, for example. Namely, the base station 100-1 stores communication history information when radio communicating with the terminal 200. FIG. 13A is a diagram illustrating an example of the communication history information. The communication history information includes the time when radio communication is performed and the position of the terminal 200 when radio communication is performed. For example, the call connection processing unit 142, when receiving data transmitted from the terminal 200 and transmitting data to the terminal 200, stores the reception time and the transmission time into the knowledge DB 1465. Also, when acquiring position information included in the message etc. transmitted from the terminal 200, the call connection processing unit 142 stores the acquired position information into the knowledge DB 1465. Then, according to the attribute of the area 600 in which the terminal 200 is located, the interface 1463 decides the mobility of the area 600. More specifically, the interface 1463 confirms each terminal 200 whose calculated moving distance in the area 600 is equal to or greater than a mobility decision threshold. If the number of such terminals 200 is equal to or greater than a number decision threshold, the interface 1463 decides to be a “high mobility area”. If otherwise, the interface 1463 decides to be a “low mobility area”. The interface 1463 stores the decision result for each area 600 into the knowledge DB 1465. FIG. 13B illustrates an example of each mobility decision result stored in the knowledge DB 1465. As depicted in FIG. 13B, for example, information whether the mobility is high (“High” in FIG. 13B) or low (“Low” in FIG. 13B) for each area is stored in the knowledge DB 1465 on a time-by-time basis. This enables the interface 1463 to read out, based on the position information and the time information included in the measurement report, the corresponding mobility decision result from the knowledge DB 1465 to decide the mobility.

Referring back to FIG. 12, next, the base station 100-1 decides to apply either one of the modes of the cooperative communication according to the mobility decision result of the area, to execute the processing of the mode concerned (S33).

In the present second embodiment, in the base station 100-1, the mobility of the area 600 in which the terminal 200 is located is decided, and if the mobility of the area 600 concerned is “low”, the CB scheme is applied, whereas if the mobility of the area 600 concerned is “high”, the CS scheme is applied.

The reason for such application of each mode is that efficiency in the processing of the base stations 100-1, 100-2 is taken into account, for example. For example, when the number of terminals traveling in the area 600 in which the terminal 200 is located is greater than a constant number, if beamforming is made to the area 600 under the CB mode, it comes to that the beamforming is made to terminals traveling to a variety of directions. In comparison of such a case with a case of beamforming to a stationary terminal, the processing of the latter case is easier. On the other hand, when the number of terminals traveling in the area 600 is greater than a constant number, if the CS mode is applied for a travel destination area 600 traveling to a variety of directions, it is possible to allocate each radio resource according to the travel, so that can execute processing according to the travel of the terminal 200.

Here, the application of the cooperative communication modes may be possible using another combination of modes than mentioned above. For example, the base station 100-1 may apply the CS mode if the mobility of the area 600 is “low”, and the CB mode if the mobility is “high”. There are four modes applicable for the cooperative communication, which are the CB mode, the CS mode, the JP mode DPS and the KP mode JT, for example. The base station 100-1 may apply either one of the modes according to the decision result of the mobility of the area 600.

The processing of S33 is different depending on each mode. The details thereof will be described later. In S33, it is decided whether or not to execute the cooperative communication targeted for the area 600.

Next, the base station 100-1 transmits to the base station 100-2 a set value etc. when executing the cooperative communication (S34). In this case, as the set value, there are a set value when executing the ordinary cooperative communication and a set value when executing the cooperative communication targeted for the area 600. The exchange of the set values between the two base stations 100-1, 100-2 causes information sharing related to the cooperative communication.

Next, the terminal 200 starts a service start request (S35), to transmit the service start request to the base station 100-1 (S36).

The base station 100-1, on receiving the service start request, acquires the QoE of the area 600 in which the terminal 200 is located (S37), to notify the terminal 200 (S38).

According to the received QoE, the terminal 200 selects whether or not to execute a service start request (S39), and when executing the service start, transmits the service start request to the base station 100-1 (S40).

Then, the base station 100-1 transmits the service start request to a content server etc., for example, and on receiving a service start notification for the request concerned, transmits the above notification to the terminal 200 (S41).

Thereafter, the two base stations 100-1, 100-2 transmit data in cooperation (S42, S43). In this case, for example, the two base stations 100-1, 100-2, when executing the ordinary cooperative communication, transmit data to the terminal 200, whereas when executing the cooperative communication targeted for the area 600, transmit data to the area 600.

Incidentally, in regard to the service start selection (S39), there is a case when the terminal 200 does not request to start the service because the QoE does not take a satisfactory value. In such a case, the base station 100 may transmit to the terminal 200 time and a place producing satisfactory QoE, together with the QoE. This enables the terminal 200 to receive the service at the time and the place producing satisfactory QoE.

In the above-mentioned overall operation example, the description is given on an example when, for example, after the terminal 200 executes the service request, the terminal 200 does not travel during a period before receiving the service provision. An example when the terminal 200 travels before receiving the service provision will be described below.

<4.2.1 Example When the Terminal 200 Travels>

There are cases when the terminal 200 is stationary in the area 600 and travels. When the terminal 200 travels, according to the present second embodiment, the base station 100 calculates the travel destination area 600 of the terminal 200. There is also a case when the base station 100 estimates QoE for the travel destination area 600. In the following, a description will be given on how the base station 100 calculates the travel destination area 600 when the terminal 200 travels.

With regard to the travel of the terminal 200, there are cases when a travel route is known and unknown, for example. First, a case that the travel route is known is described. For example, there is a case when a user using the terminal 200 gets on a train, a bus, etc. to travel. As to the train and the bus, the travel routes thereof are already known, and in that case, the terminal 200 travels along the known travel route. In the following, by taking an example of a train as a moving body (or a moving means; which may hereafter be referred to as moving body), a case that the user using the terminal 200 travels with the train will be described.

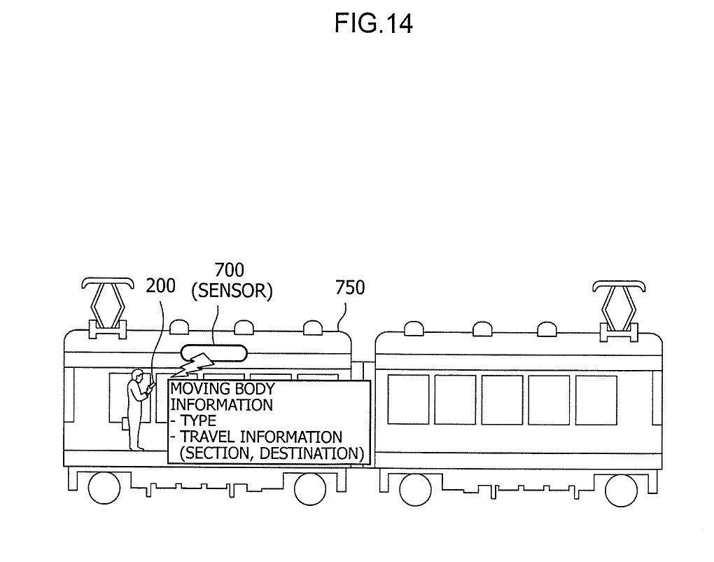

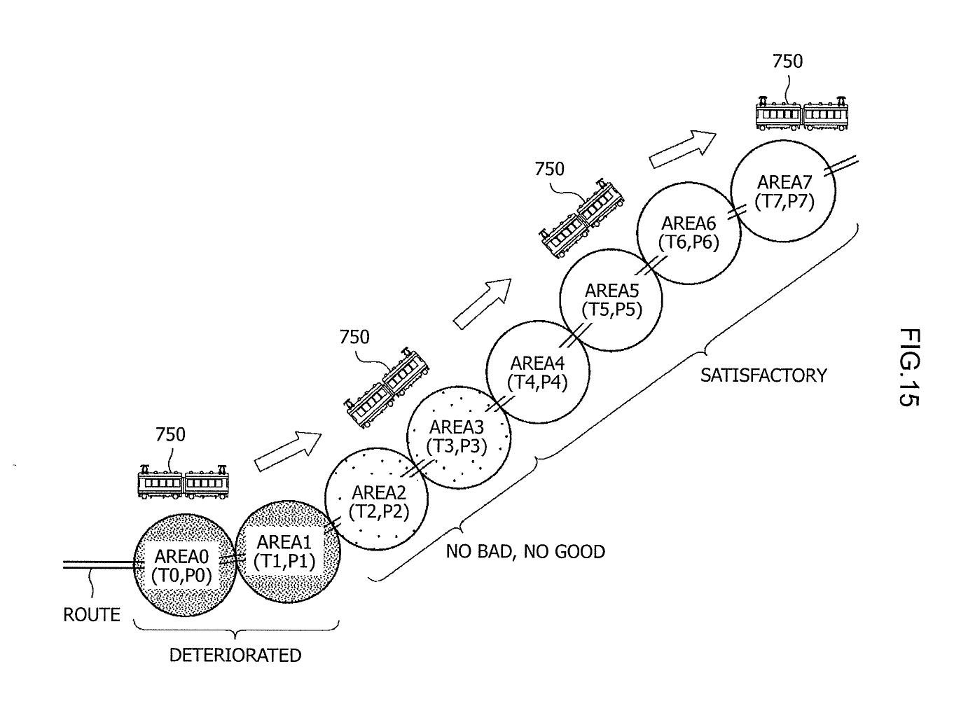

FIG. 14 is a diagram illustrating a state that the user using the terminal 200 travels with a train 750. The train 750 is provided with a sensor (or small radio equipment) 700.

The sensor 700 transmits moving body information, which the terminal 200 receives. As the moving body information, there are a moving body type, a travel section, a destination, position information, etc., for example. The terminal 200 transmits the received moving body information to the base station 100 to request a service, for example.

FIG. 15 is a diagram illustrating an example of each area 600 on the travel route and an example of QoE in the area 600. In FIG. 15, it is indicated that the QoE of the terminal 200 on the train 750 is “deteriorated” when the train 750 is located in a place (P0) (or an “area 0”) at time (T0). Also, it is indicated that, when the train 750 travels to a place (P3) (or an “area 3”) at time (T3), the QoE of the terminal 200 at the place (P3) becomes “no bad, no good”, and when travels to a place (P5), the QoE of the terminal 200 becomes “satisfactory”.

When the travel route is already known, if time (TX) is fixed then a place (PX) is fixed uniquely, and therefore, it can be considered in the base station 100 that predicting a place (PX) in which the QoE becomes satisfactory is identical to predicting time (TX) in which the QoE becomes satisfactory.

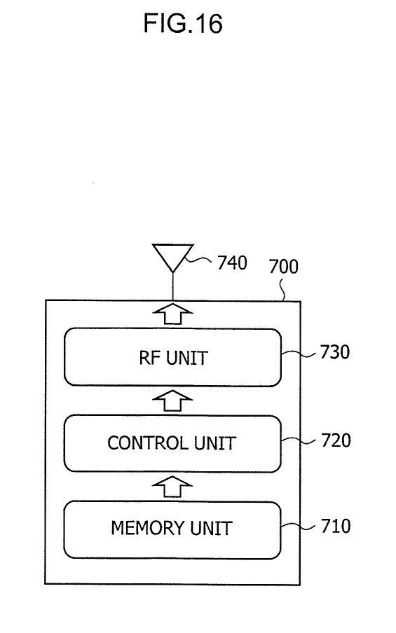

FIG. 16 is a diagram illustrating a configuration example of the sensor 700. The sensor 700 includes a memory 710, a controller 720, an RF section 730 and an antenna 740.

The memory 710 stores moving body information, for example.

The controller 720 reads out from the memory 710 the moving body information stored in the memory 710, and performs modulation processing etc. thereon to output to the RF section 730.

The RF section 730, on receiving from the controller 720 the moving body information on which the modulation processing etc. are performed, converts the moving body information into a radio signal in a radio band, and outputs the converted radio signal to the antenna 740.

The antenna 740 transmits the radio signal received from the RF section 730.

For example, the controller 720 periodically reads out the moving body information stored in the memory 710 to output to the RF section 730, so that the moving body information is transmitted to the terminal 200 periodically.

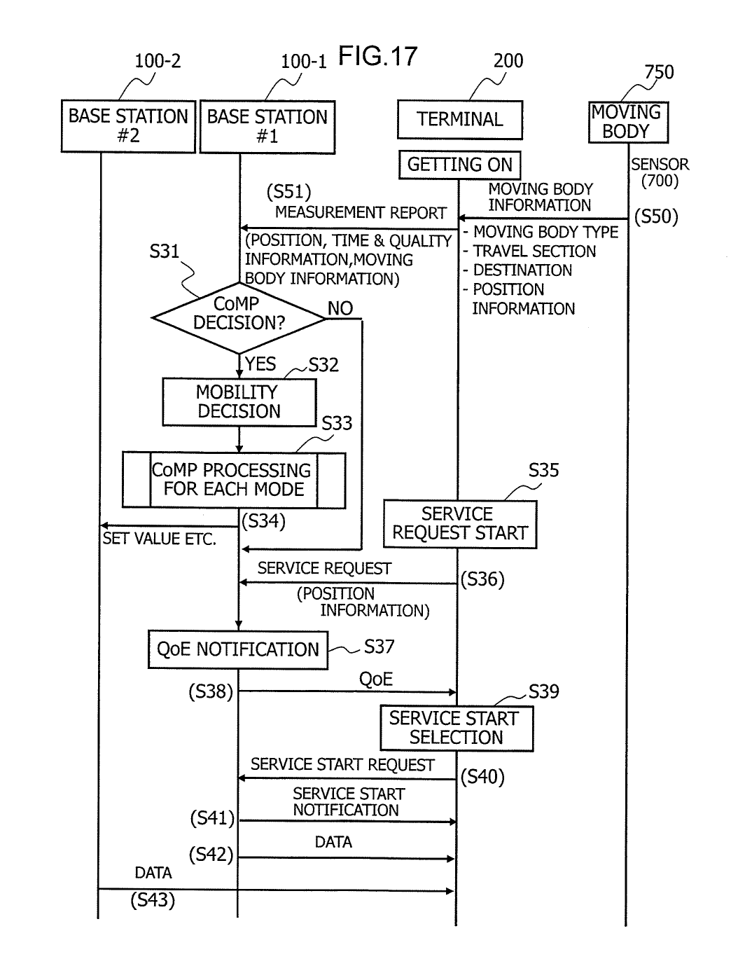

FIG. 17 is a diagram illustrating a sequence example of the overall operation example when the terminal 200 travels. The same symbol is given to the same processing as in FIG. 11.

The sensor 700 transmits the moving body information, so that the terminal 200 acquires the information on the train 750 (S50). The moving body information includes, for example, “train” (=moving body type), “between Ofuna and Omiya (=travel section), Omiya (=destination), Kawasaki (=position information), etc. The above moving body information represents that a user using the terminal 200 is on a train 750, of which travel section is “between Ofuna and Omiya” and which is destined for “Omiya”, from “Kawasaki” station.

Next, the terminal 200 transmits a measurement report (S51). In this case, the terminal 200 transmits the measurement report by including the moving body information in addition to quality information, position information and time information.

Thereafter, the similar processing (S31-S43) as in the overall operation example depicted in FIG. 12 is carried out.

Because the travel route of the train 750 is known, the base station 100 can calculate a direction (for example, “up direction”, “direction toward Omiya”, or the like) to which the train 750 is traveling and a route (“Keihin-Tohoku line”) which is passed through from the present point (P0), on the basis of the position information (“Kawasaki”), the travel section (“between Ofuna and Omiya”), the destination (“Omiya”), map information, and so on. Therefore, the base station 100 can calculate each place (PX) (or area 600) to pass through from the present point (P0) to an arrival at the destination (“Omiya”), for example.

Further, the base station 100 can also determine the travel speed of the moving body from the moving body type information (“train”), for example, and moreover, can calculate the arrival time (TX) at each place (PX) passing through from the present point (P0), on the basis of the travel speed, the travel diagram information of the train 750, etc.

Therefore, as depicted in FIG. 15 for example, the base station 100 can calculate each place (PX) to pass through (or area 600) and the arrival time (TX) at the place. Then, using each calculated place (PX) and time (TX) as search keys, the base station 100 extracts QoE at each place and time from the knowledge 1465, so that can predict QoE. Thus, also in the present embodiment, the base station 100 can search the knowledge DB 1465 for the QoE of each area 600 and a place (P4) in which the QoE becomes satisfactory.

Such processing can be executed in the following manner, for example. Namely, the measurement report input unit 143, on receiving a measurement report, extracts position information and moving body information to output to the QoE processing unit 146. The interface 1463 of the QoE processing unit 146 calculates the arrival time of the terminal 200 at each area 600, on the basis of the position information and the moving body information, to request the first QoE prediction unit 1467 to acquire the QoE at the arrival time at each area 600, from the knowledge DB 1465. The first QoE prediction unit 1467 reads out QoE in accordance with the request from the knowledge DB 1465, to output through the notification processing unit 1470 etc. to the call connection processing unit 142 and the CoMP comparison & decision processing unit 148.

As such, when the travel route is known, the base station 100-1 can io calculate the QoE at the arrival time at each area 600, on the basis of the position information and the moving body information included in the measurement report, for example, and thereby can also estimate the QoE of the terminal 200 after the lapse of a predetermined time.

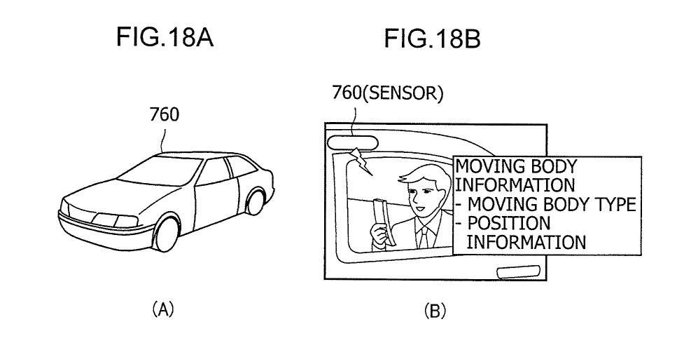

Next, a description will be given on an example when the travel route is unknown. FIG. 18A is a diagram illustrating an example of an automobile 760 as a moving body. When a user who gets in the automobile uses a terminal 200, the travel route of the terminal 200 is unknown. A sensor 700 is provided on the automobile 760, so that the terminal 200 acquires moving body information from the sensor 700. In this case, the terminal 200 transmits a measurement report including the moving body information (for example, S51 in FIG. 17), and further transmits service information (S36).

Based on the position information included in the above two messages etc., the base station 100 calculates the travel route of the terminal 200, so that can acquire a travel destination area 600 of the terminal 200 after the lapse of a predetermined time. Then, similar to the case when the route is known, the base station 100 can acquire the QoE of the travel destination area 600, so that can output the QoE in accordance with the request to the call connection processing unit 142 and the CoMP comparison & decision processing unit 148.

<4.3 Initial Value Registration to the Knowledge DB>

Next, a description will be given on the registration processing of an initial value to the knowledge DB 1465. At early operation of the present mobile communication system 10, it is assumed that the number of samples in the knowledge DB 1465 is few and therefore the accuracy of QoE is low. For this reason, the base station 100 is configured to store QoE into the knowledge DB 1465 using an initial DB decision rule, when the number of samples is insufficient. This enables the storage of QoE with high accuracy if the number of QoE samples is insufficient, for example.

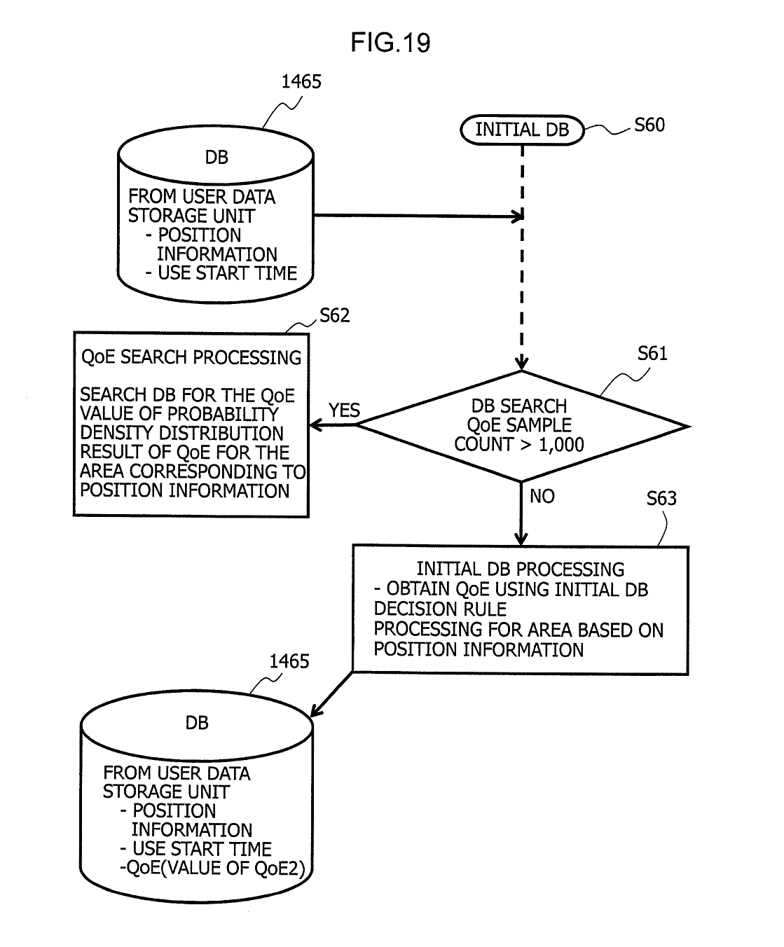

FIG. 19 is a flowchart illustrating an example of initial DB processing for the knowledge DB 1465. The base station 100 decides whether or not the total number of QoE samples stored in the knowledge DB 1465 exceeds “1000” (S60-S61). Here, “1000” is an example of a threshold specifying whether or not the number of samples is sufficient, so that other numerals may be applicable.

If the number of samples is “1000” or smaller (N in S61), the base station 100 executes the initial DB processing using the initial DB decision rule (S63). On the other hand, if the number of samples exceeds “1000” (Y in S61), the base station 100 stores the above-mentioned QoE representative value into the knowledge DB 1465.

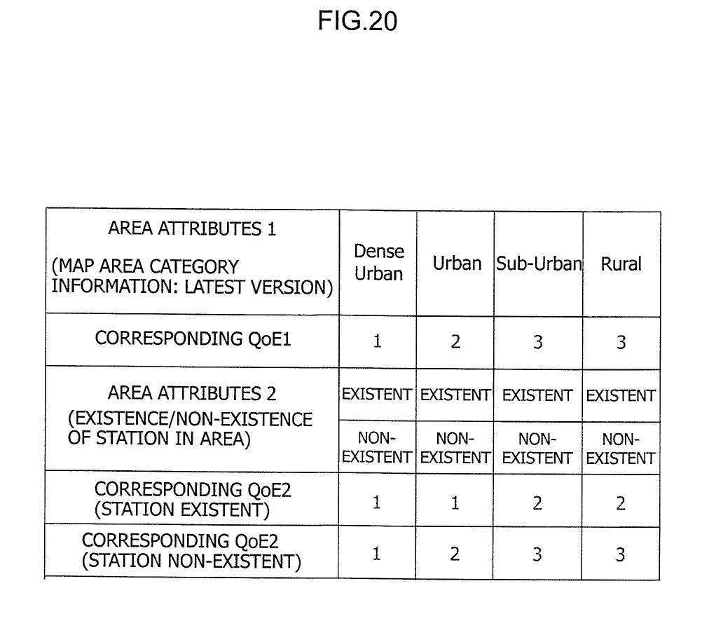

FIG. 20 is a diagram illustrating an example of the initial DB decision rule. For example, a variety of attribute information sets are added to map information. In the knowledge DB 1465, map data to which the attribute information is added is stored, for example.

In the initial DB decision rule, QoE at each area 600 is calculated based on two attribute information sets which are an “area category” and “existence or non-existence of railroad station”, so as to be stored into the knowledge DB 1465. In the example of FIG. 20, when the “area category” of the area 600 is a high-rise building group (dense urban [metropolitan] area), heavy traffic is expected, and therefore QoE takes “1” (=QoE(1)). Also, when a railroad station exists in the area 600 concerned (“station existent”), heavy traffic is expected, and therefore, the QoE of the area 600 concerned is decided to be “(QoE determined from the area category)−1”. On the other hand, when there is no station in the area 600 concerned (“station non-existent”), low traffic is assumed, and therefore, the value of the QoE determined from the “area category” is maintained intact.

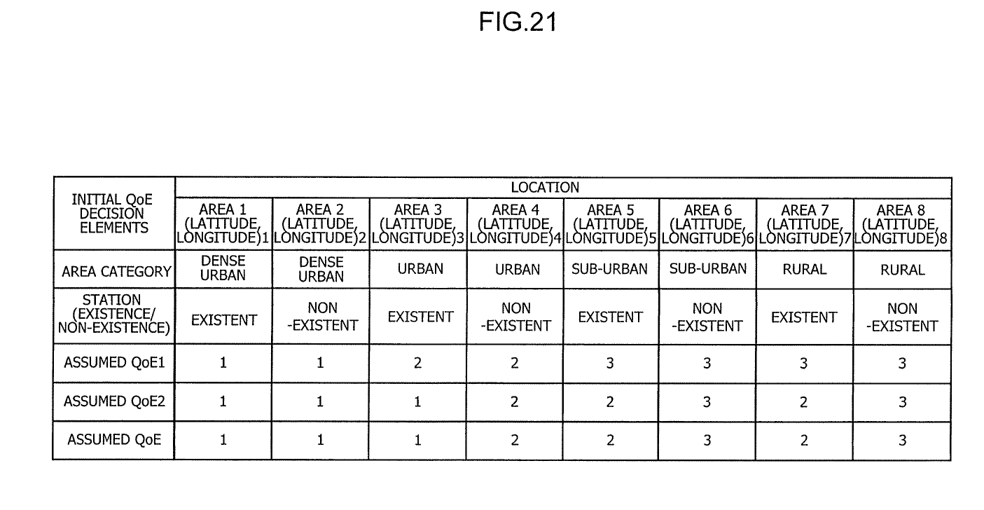

FIG. 21 is a diagram illustrating an example of QoE which is decided using such an initial DB decision rule, and as an initial value, “assumed QoE” is stored in the knowledge DB 1465.

<4.4 Each Processing Flow for QoE Calculation Processing etc.>

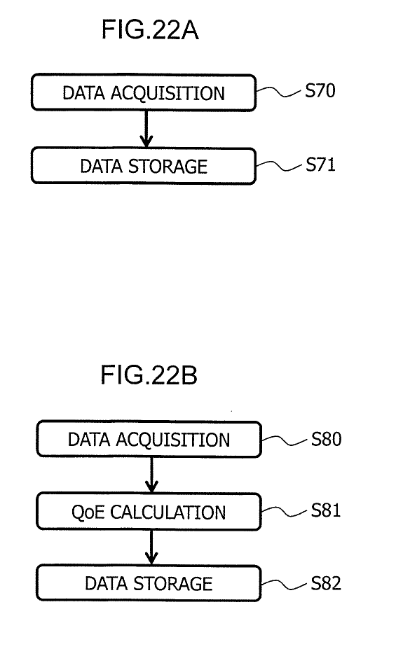

Next, a description will be given on each of the above-mentioned processing executed in the base station 100. FIG. 22A through FIG. 28 are flowcharts illustrating each processing operation example. Each parts of description duplicate with the above-mentioned operation example will be described in brief.

FIGS. 22A and 22B illustrate examples of data storage processing when the base station 100 acquires data from the terminal 200. The above examples correspond to, for example, the collection of user data information (for example S11 in FIG. 7) and the calculation of QoE (for example, S24 in FIG. 9).

In the example depicted in FIG. 22A, the base station 100 stores the acquired data into the knowledge DB 1465 intact (S70-S71). In contrast, in the example depicted in FIG. 22B, the base station 100 calculates QoE and stores the calculated QoE into the knowledge DB 1465 (S80-S82).

In the examples of FIGS. 22A and 22B, data to be stored is user data information, and the user data information includes the position information (S16,

S18, etc. in FIG. 8) and the moving body information (S50 etc. in FIG. 17) of the terminal 200.

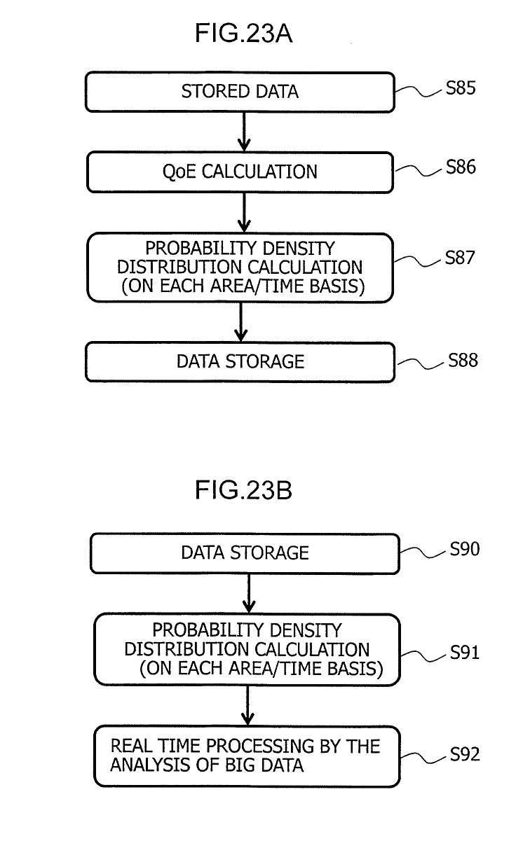

FIGS. 23A, 23B are flowcharts illustrating examples of probability density distribution processing. The probability density distribution processing corresponds to, for example, S25 in FIG. 9.

In the example of FIG. 23A, the base station 100 reads out QoE from the knowledge DB 1465 and calculates probability density distribution to store into the knowledge DB 1465 (S85-S88). For example, the QoE probability density distribution calculation unit 1466 reads out QoE from the knowledge DB 1465, on the basis of each area 600 and time, to store into the knowledge DB 1465 the QoE of the highest probability density in the group concerned.

In contrast, the example of FIG. 23B is a case when the base station 100 can execute real time processing through big data analysis, in which the base station 100 instantaneously calculates probability density distribution from the stored data to store into the knowledge DB 1465 (S90-S92).

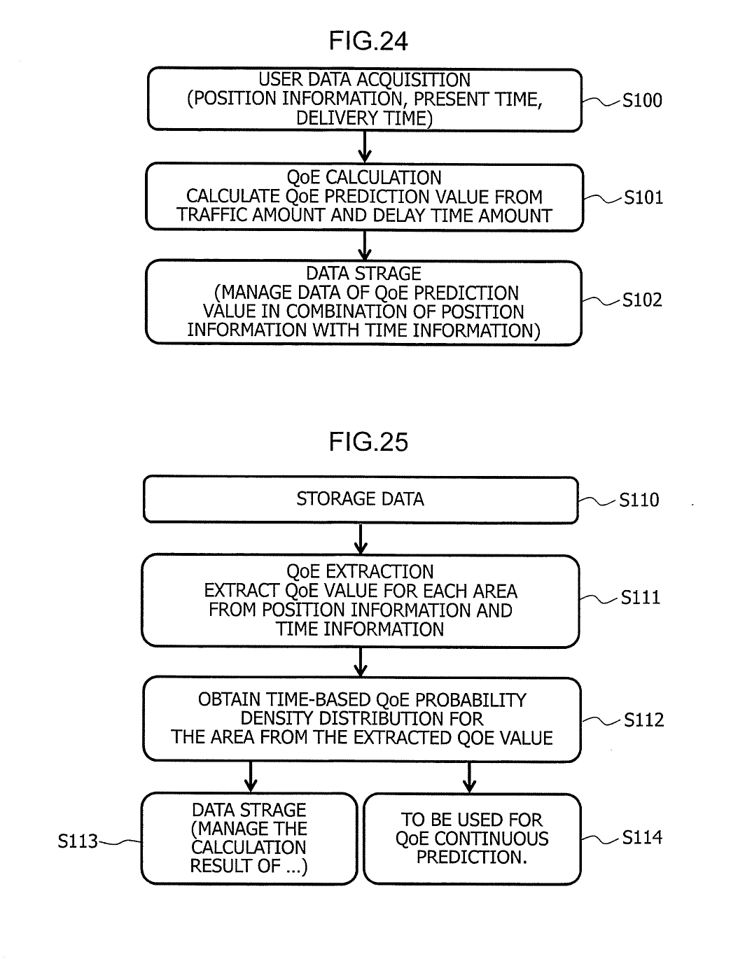

FIG. 24 is a flowchart illustrating an example of QoE calculation processing. The above flowchart is also a flowchart illustrating the detailed processing of FIG. 22B.

The base station 100, on acquiring user data information (S100), calculates QoE on the basis of a traffic amount and a delay time amount, using the QoE decision rule (for example, FIG. 10). The base station 100 stores the calculated QoE into the knowledge DB 1465 (S102).

FIG. 25 is a flowchart illustrating an example of probability density distribution processing, which is also a flowchart illustrating the detailed processing depicted in FIG. 23A.

The base station 100 extracts QoE from the knowledge DB 1465 (S111), calculates the probability density distribution of the QoE (S112), and stores into the knowledge DB 1465 the QoE of the highest probability density, for example, as the QoE of the group concerned (S113). The QoE stored in the knowledge DB 1465 is used to predict QoE (S26 in FIG. 9) in the group concerned (S114).

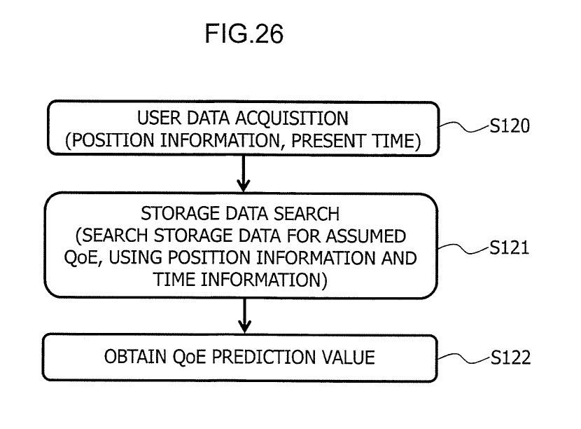

FIG. 26 is a flowchart illustrating an example of QoE prediction processing. The present processing is also processing which corresponds to S26 in FIG. 9, for example.

The base station 100, on receiving a service request message for example, acquires user data information (S120). Then, the base station 100 extracts QoE from the knowledge DB 1465 using position information and time information as search keys (S121-S122). The extracted QoE is QoE which is predicted to be received when a user receives the delivery of a service content, for example, and is also QoE which is predicted at the terminal 200 after the lapse of a predetermined time.

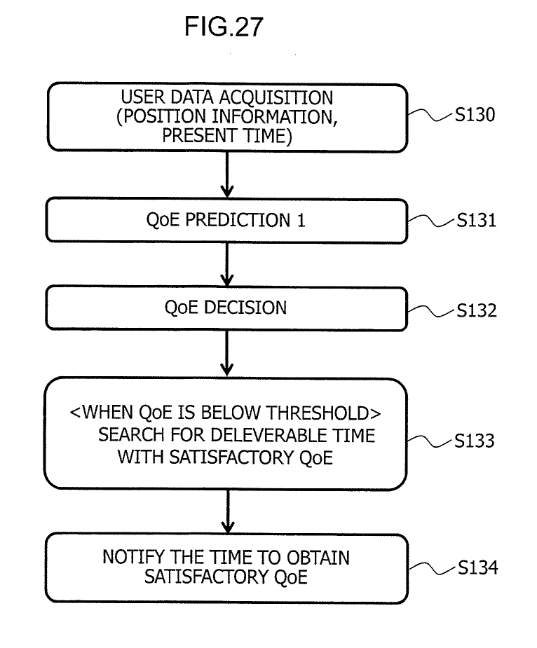

FIG. 27 is a flowchart illustrating an example of processing when the user uses a service. The present processing relates to S38 to S39 of FIG. 12, for example.

The base station 100, on receiving the service request message, acquires position information and time, to extract corresponding QoE from the knowledge DB 1465 (S130-S131).

Next, the base station 100 compares the extracted QoE with a threshold, so as to decide whether or not the QoE is lower than and including the threshold (S132). On deciding that the QoE is lower than and including the threshold, the base station 100 searches the knowledge DB 1465 for the time at which delivery can be made with satisfactory QoE (S133), to notify the time of the search result (S134). The search object may be a place, not only the time.

<4.5 Example of the Area>

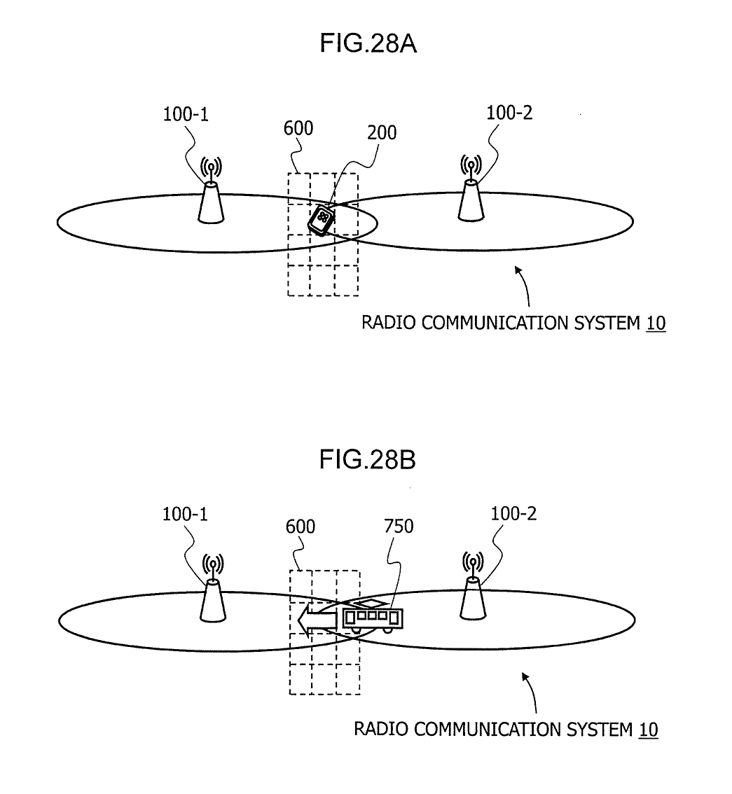

FIGS. 28A and 28B are diagrams illustrating each example of an area 600 in the radio communication system 10. FIG. 28A illustrates an example when the terminal 200 is stationary, whereas FIG. 28B illustrates an example when the terminal 200 travels with the traveling train 750.

The area 600 is, for example, an area in which cooperative communication is to be executed, and is set in the mutually overlapped cell range of a plurality of base stations 100-1, 100-2. The area 600 includes, for example, the overlapped cell range, and a part of the area 600 may be out of the cell range concerned.

According to the present second embodiment, the plurality of base stations 100-1, 100-2 execute the cooperative communication targeted for the area 600. At that time, as mentioned earlier, the plurality of base stations 100-1, 100-2 manage the distribution, the behavior, etc. of the terminals which are distributed in the area 600, and decide the mobility in the area 600. The base stations 100-1, 100-2 are configured to select a mode for cooperative communication according to the mobility, to execute the cooperative communication targeted for the area 600 under the selected mode.

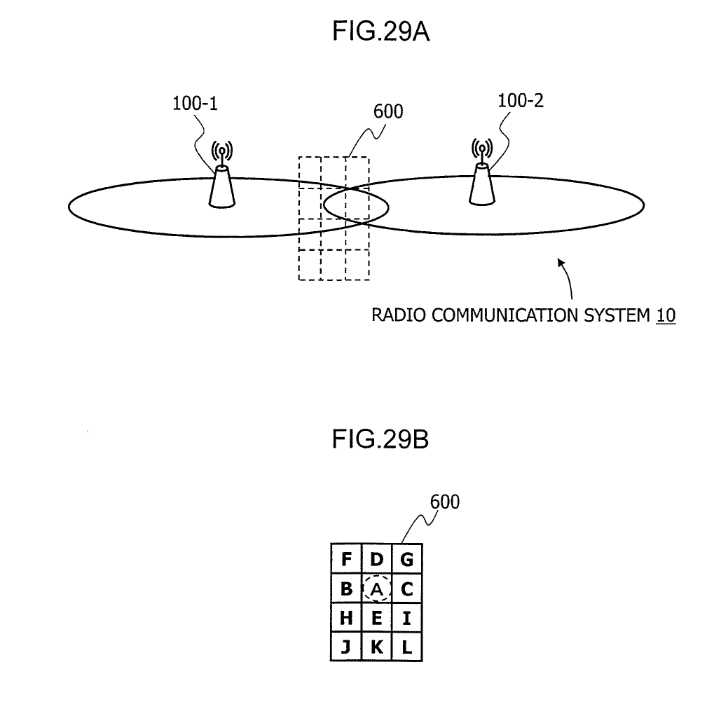

FIG. 29A illustrates an example of the area 600, and FIG. 29B illustrates an example when identification information is given to a small area, respectively. As depicted in FIG. 29B, in the area 600, identification information from an area “A” to an area “L” may be given to each small area. For example, each base station 100-1, 100-2 manages the area 600 on the basis of map information etc., so that can manage the range of the area “A” using longitude and latitude information. Such map information is stored in the knowledge DB 1465, for example, and based on the position information related to the longitude and latitude, the QoE processing unit 146 can read out the QoE of the area 600 corresponding to the position information concerned from the knowledge DB 1465.

As mentioned earlier, the base station 100 selects a mode related to the cooperative communication on the basis of the decision result of mobility in the area 600 in which the terminal 200 is located (for example, S32 in FIG. 12). According to the present second embodiment, the CB mode is selected if the mobility of the location area 600 is “low”, whereas the CS mode is selected if the mobility of the location area 600 is “high”. In the following, a description will be given first on a case when the CB mode is applied, followed by a case of the CS mode, and finally a case when the JP mode is applied.

<4.6 CB Mode Operation Example>

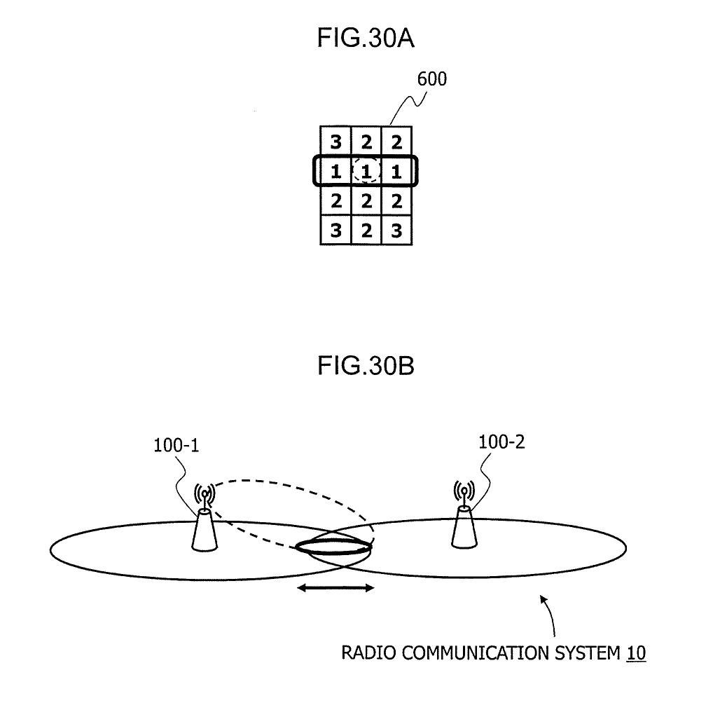

An operation example when the CB mode is applied will be described. FIG. 30A through 32 are diagrams illustrating an operation example when the CB mode is applied.

Each base station 100-1, 100-2 stores the QoE of each area 600 in the knowledge DB 1465, for example. FIG. 30A illustrates an example of QoE at a certain time, which is stored in the knowledge DB 1465 of the base station 100-1. Here, each small area in the area 600 is identified by identification information as depicted in FIG. 29B, which is also applied to operation examples hereinafter.

In the present operation example, when the QoE of the area 600, in which the terminal 200 is currently located, and the QoE of the peripheral area 600 thereof consecutively take “1” (which is a value indicating the QoE is deteriorated), it is decided to execute cooperative communication targeted for the area 600, so that beamforming to the area 600 concerned is executed under the CB mode.

FIG. 30B illustrates a state that, because areas “A” to “C” take “1”, the base station 100-1 executes beamforming to the areas “A” to “C” under the CB mode.

On the other hand, in a case when the QoE of the location area 600 of the terminal 200 is equal to or greater than “2”, or when the location area takes “1” but the adjacent area takes equal to or greater than “2”, the base station 100-1 determines not to execute cooperative communication targeted for the area 600.

As such, based on the distribution of QoE, the base station 100-1 decides whether or not to execute the cooperative communication targeted for the area 600. The detail will be described later.

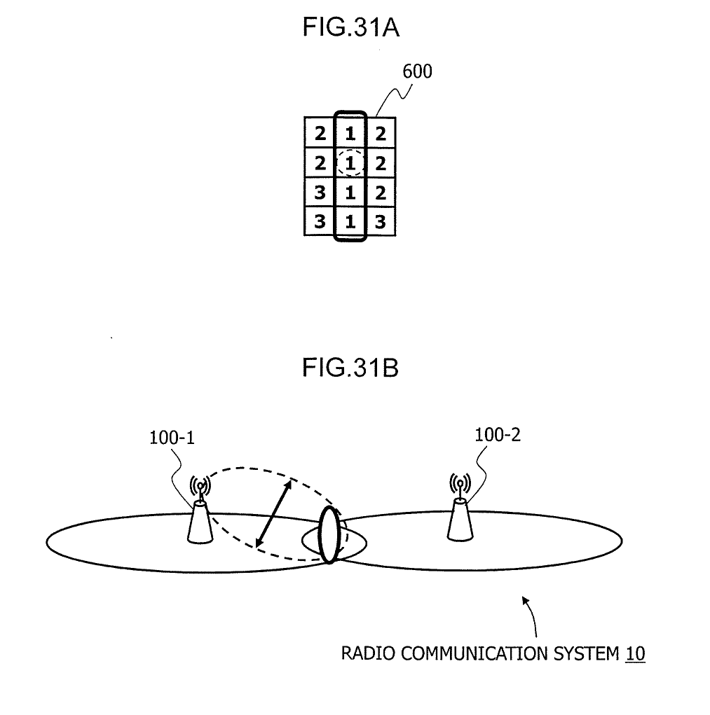

In the example of FIG. 31A, the QoE of the area “A” in which the terminal 200 is located and the QoE of each area “D”, “E”, “K” take “1”. In this case also, the base station 100-1 determines to execute cooperative communication targeted for the areas “A”, “D”, “E” and “K”. FIG. 31B illustrates a state in which beamforming to these areas 600 is being executed under the CB mode.

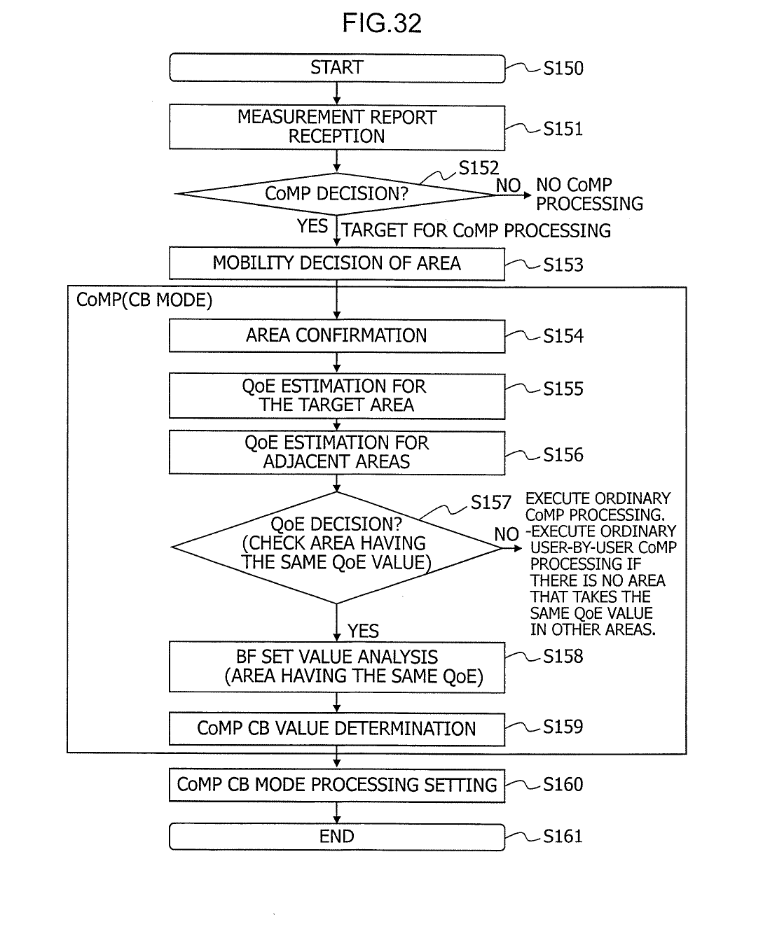

FIG. 32 is a flowchart illustrating an operation example when the CB mode is applied. The operation example depicted in FIG. 32 illustrates, for example, the operation example of S31 to S34 in the overall operation example (for example, FIG. 12).

The base station 100-1, when starting processing (S150), receives a measurement report (S151).

Next, the base station 100-1 decides whether or not to execute ordinary cooperative communication (S152). For example, the CoMP decision unit 144 of the base station 100-1 makes the decision on the basis of quality information included in the received measurement report.

On deciding not to execute the ordinary cooperative communication (N in S152), the base station 100-1 terminates the processing without executing the cooperative communication.

On the other hand, on deciding to execute the ordinary cooperative communication (Y in S152), the base station 100-1 decides the mobility of the area 600 (S153).

For example, the following processing is carried out. Namely, the CoMP comparison & decision processing unit 148 of the base station 100-1 receives, from the CoMP decision unit 144, “CoMP processing existent”, and position information and time information included in the measurement report. The CoMP comparison & decision processing unit 148 outputs the position information and the time information to the QoE processing unit 146, so as to acquire information related to the mobility of the area 600 concerned (for example, “the mobility is high” or “the mobility is low”) from the knowledge DB 1465 of the QoE processing unit 146. Then, based on the acquired information related to the mobility, the CoMP comparison & decision processing unit 148 selects a cooperative communication mode. In the present example, because of acquiring information that “the mobility is low”, the CoMP comparison & decision processing unit 148 selects the CB mode for the area 600.

Next, the base station 100-1 confirms the area 600 (S154). The base station 100-1 confirms the location area 600 of the terminal 200 and the adjacent areas thereof. For example, based on the position information included in the measurement report, the CoMP comparison & decision processing unit 148 confirms the location area 600 of the terminal 200 and the adjacent areas 600 thereof, on the basis of the knowledge DB 1465 of the QoE processing unit 146.

Next, the base station 100-1 estimates the QoE of the target area 600 (S155). For example, the following processing is carried out. Namely, the CoMP comparison & decision processing unit 148 outputs to the QoE processing unit 146 a QoE acquisition request which includes the position information and the time information included in the measurement report. The interface 1463 of the QoE processing unit 146 acquires, from the knowledge DB 1465, QoE which corresponds to the position information and the time information included in the acquisition request concerned, to output to the CoMP comparison & decision processing unit 148.

Here, the CoMP comparison & decision processing unit 148 may calculate QoE on the basis of the position information and the time information included in the measurement report. For example, QoE at the reception of the measurement report may also be applicable.

Next, the base station 100-1 estimates the QoE of the adjacent areas 600 (S156). For example, the interface 1463 of the QoE processing unit 146 acquires from the knowledge DB 1465 the QoE of each area 600 which is adjacent to the area 600 for which the QoE is acquired in S155, so as to output to the CoMP comparison & decision processing unit 148.

Next, the base station 100 decides QoE (S157). For example, as described earlier, when the QoE at the time when the terminal 200 is located in the area 600 is “1”, and there are consecutive adjacent areas 600 which take the same “1” at the same time as the above, the base station 100-1 determines to execute cooperative communication targeted for the area 600.

In general, QoE often takes the same value among consecutive areas 600. Therefore, when the QoE of the location area 600 takes “1”, the QoE in the adjacent areas 600 often takes “1”. When the QoE is consecutive for areas 600, for example, it is effective to execute cooperative communication targeted for such areas 600 having consecutiveness, using the CB mode.

Referring back to FIG. 32, the base station 100-1, on determining from the QoE decision that cooperative communication targeted for the area 600 is not to be executed (N in S157), the base station 100-1 executes ordinary cooperative communication. The base station 100-1 executes cooperative communication for each individual terminal 200, for example. The CoMP comparison & decision processing unit 148 outputs to the CoMP decision unit 144 the decision result indicating that the cooperative communication is not to be executed, for example.

On the other hand, on determining to execute the cooperative communication targeted for the area 600 (Y in 157), the base station 100-1 analyzes a beamforming set value (which may hereafter be referred to as “BF set value”) to be executed under the CB mode (S158).

For example, the following processing is carried out. Namely, the CoMP comparison & decision processing unit 148 confirms consecutive areas 600 which take QoE of “1”. The CoMP comparison & decision processing unit 148 then outputs to the CoMP decision unit 144 the decision result indicating to execute cooperative communication targeted for the area 600, the mode decided in S153 (i.e. CB mode in the present operation example) and the information of the consecutive areas 600 which take QoE of “1”.

Next, the base station 100-1 determines a set value when executing the cooperative communication in the CB mode (which may hereafter be referred to as a “CoMP CB value”) (S159).

For example, such processing as follows is carried out. Namely, the CoMP decision unit 144, on receiving a decision result indicating that the cooperative communication targeted for the area 600 is to be executed, instructs the CoMP execution unit 145 to execute the cooperative communication targeted for the area 600. Further, in this case, the CoMP decision unit 144 also outputs the application mode and the information of the consecutive areas 600 which take QoE of “1” to the CoMP execution unit 145. On receiving the instruction, the CoMP execution unit 145 determines a set value on the basis of the application mode and the information of the consecutive areas 600 which take QoE of “1”.

As each set value in the present example, there are the power and the phase of a radio signal to be output to the antenna 110, for example. The adjustment of such power and a phase enables the concentration of a radio wave to a desired area and the execution of beamforming. In this case, the CoMP execution unit 145 can calculate the desired power and the phase using a calculation formula etc., to enable determining the set value including the calculated power and the phase.

Next, the base station 100-1 executes CB mode setting processing in the cooperative communication (S160). For example, the CoMP execution unit 145 transmits the determined set value through the interface 150 to another base station 100-2. In this case, it may also be possible for the CoMP execution unit 145 to instruct to the other base station 100-2 not to execute the cooperative communication targeted for the area 600.

The base station 100-1 then completes a series of processing (S161). Thereafter, the plurality of base stations 100-1, 100-2 execute radio communication targeted for the area 600 under the CB mode, to transmit data etc. related to a service to the area 600.

The execution of the cooperative communication targeted for the area 600 under the CB mode produces satisfactory radio communication for the area 600 concerned after the time concerned, for example. In this case, there is a case when the terminal 200 having traveled to the area 600 does not transmit the measurement report if located in the overlapped cell range of the plurality of base stations 100-1, 100-2. This causes a decrease in the number of terminals 200 which execute cooperative communication in the area 600, to enable the reduction of the processing load of each base station 100-1, 100-2, in comparison with a case when cooperative communication is executed for each individual terminal 200 at all times.

<4.7 CS Mode Operation Example>

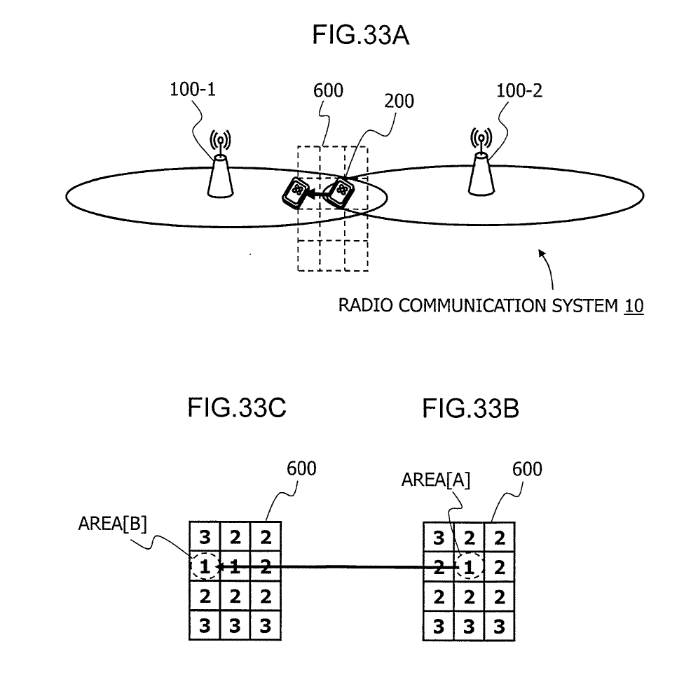

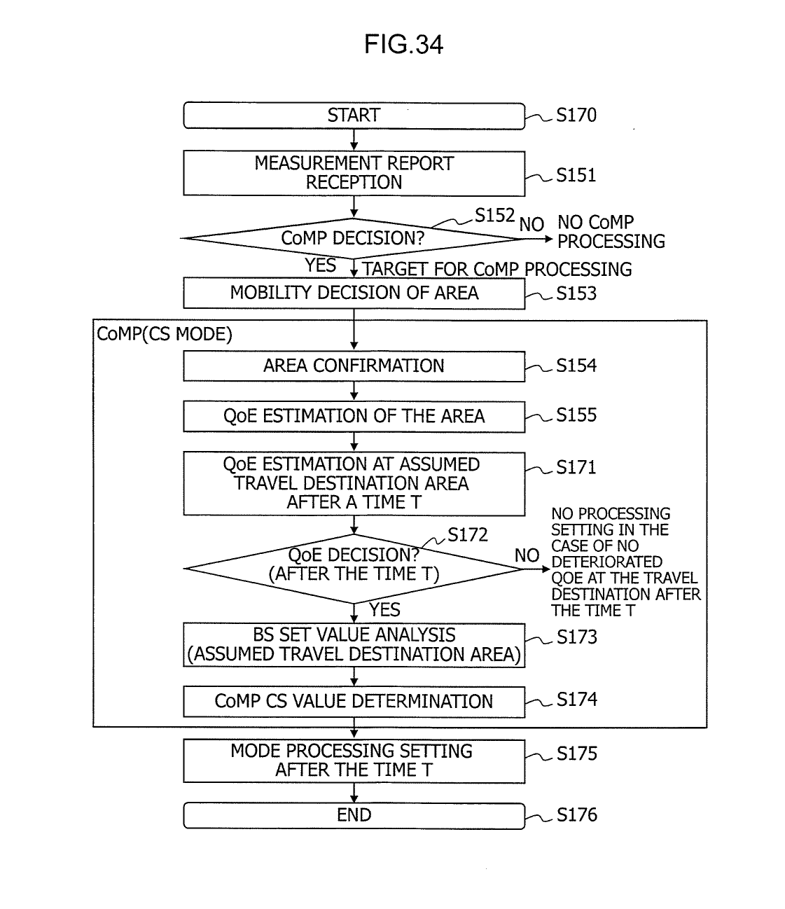

Next, a description will be given on an operation example when the CS mode is applied. FIG. 33A through FIG. 34 are diagrams illustrating an operation example when the CS mode is applied. A case when the CS mode is applied is when the mobility of the area 600 in which the terminal 200 is located is “high”.

FIG. 33A illustrates an example when the terminal 200 travels in the area 600. More specifically, there is illustrated a case when the terminal 200 is located in an area “A” and after the lapse of a time T, travels to an area “B”.

In this case, QoE when the terminal 200 is located in the area “A” at a certain time takes “1”, for example, as depicted in FIG. 33B. Then, after the lapse of time T after the above time, the QoE of the area “B” when the terminal 200 travels to the area “B” takes “1”, as depicted in FIG. 33C, for example.

For example, the base station 100-1 compares the QoE of the area 600, in which the terminal 200 is located, with the QoE of the travel destination area to which the terminal 200 travels after the time T, to decide to execute cooperative communication targeted for the area 600 if the QoE of the travel destination area 600 deteriorates. In this case, the base station 100-1 can decide to execute the cooperative communication targeted for the area 600 when the QoE of the location area takes “1” and the QoE of the travel destination area also takes “1”.

FIG. 34 is a flowchart illustrating an operation example, including such decision as mentioned above, when the CS mode is applied. The same symbols are given to the same processing parts as in the operation example of the CB mode.

The base station 100-1, after the start of processing (S170), receives a measurement report (S151) to decide whether or not to execute cooperative communication (S152).

On deciding to execute the cooperative communication (Y in S152), the base station 100-1 decides the mobility of the location area 600 of the terminal 200 (S153). In this case, the base station 100-1 obtains the decision result on the area 600 indicating that “the mobility is high”. When obtaining the decision result that “the mobility is high”, the base station 100-1 decides to apply the CS mode among the cooperative communication modes.

Next, the base station 100-1 confirms the location area 600 (S154), and estimates the QoE of the location area 600 (S155).

Next, the base station 100-1 estimates the QoE of the travel destination area 600 after the lapse of a time T (S171).

For example, such processing as follows is carried out. Namely, the interface 1463 of the QoE processing unit 146 calculates a travel destination area 600 after the lapse of the time T after the present time. In this case, as described in <4.2.1 Example when the terminal 200 travels>, the interface 1463 calculates the travel destination area 600 if the route is already known, on the basis of the moving body information and the position information included in the measurement report. Also, if the route is unknown, the interface 1463 calculates the travel destination area 600 on the basis of two sets of position information which are included in the measurement report and the service request. Then, the interface 1463 reads out from the knowledge DB 1465 to estimate the QoE of the calculated travel destination area 600 after the lapse of the time T.

Next, the base station 100-1 performs QoE decision (S172).

For example, such processing as follows is carried out. Namely, the CoMP comparison & decision processing unit 148 receives from the QoE processing unit 146 the QoE of the location area 600 and QoE after the lapse of the time T. Then, if the QoE of the area 600 after the time T is deteriorated as compared to the QoE of the area 600 in which the terminal 200 is located, the CoMP comparison & decision processing unit 148 decides to execute cooperative communication targeted for the area 600 (Y in S172). In this case, it may also be possible for the CoMP comparison & decision processing unit 148 to decide to execute the cooperative communication targeted for the area 600, if both the QoE of the travel destination area 600 and the QoE of the location area 600 take values indicative of deterioration (for example, “1” or the like). On the other hand, if the QoE of the travel destination area 600 after the time T becomes higher than the QoE of the area 600 in which the terminal 200 is located, or if both of the QoE maintain satisfactory values, the CoMP comparison & decision processing unit 148 decides not to execute the cooperative communication targeted for the area 600 (N in S157). In this case, the base station 100-1 executes ordinary cooperative communication.

On deciding to execute the cooperative communication targeted for the area 600 (Y in S172), the base station 100-1 analyzes a CS set value (S173). For example, the CoMP comparison & decision processing unit 148 outputs the decision result and information related to the travel destination area 600 after the time T, through the CoMP decision unit 144 to the CoMP execution unit 145.

Next, the base station 100 determines a set value when executing cooperative communication under the CS mode (S174). For example, the CoMP execution unit 145 is configured to execute scheduling by taking into account that the terminal 200 travels in the area 600 after the time T. Typically, for example, the CoMP execution unit 145 executes time setting etc. so that the scheduling is executed after the time T.

Next, the base station 100-1 performs CS mode set processing after the time T (S175). For example, the CoMP execution unit 145 notifies the other base station 100-2 of the execution of scheduling the terminal 200 located in the area 600 after the time T. In this case, the CoMP execution unit 145 may notify the other base station 100-2 either not to execute the scheduling of the terminal 200 or to execute the scheduling.

Then, the base station 100-1 completes a series of processing (S176).

In regard to processing under the CS mode, for example, the base station 100-1 schedules the terminal 200 after the lapse of the time T. Therefore, if the CS mode is applied, the base station 100-1 executes scheduling for each individual terminal 200. However, there may be a case when the CB mode is selected according to the mobility decision of the area 600 (for example, S153 of FIG. 32). As a result, in comparison with a case when cooperative communication is executed for the individual terminal 200 at all times, the present radio communication system 10 can reduce processing for the base stations 100-1, 100-2.

<4.8 JP Mode Operation Example>

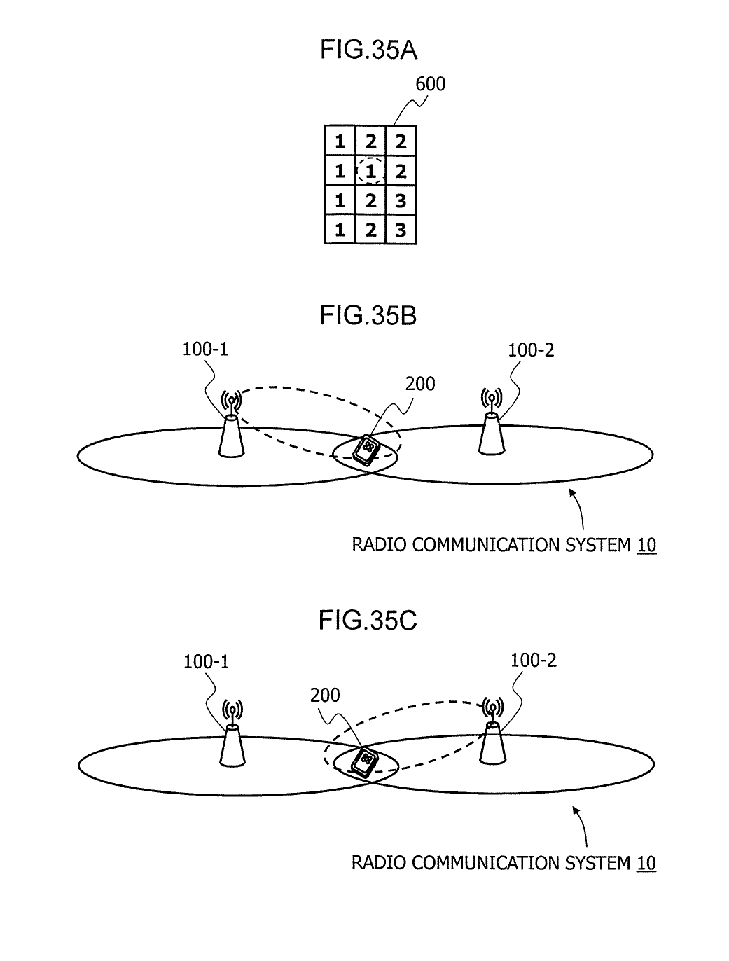

Next, a description will be given on an operation example when the JP mode is applied. FIGS. 35A through 37 are diagrams illustrating an operation example when the JP mode is applied.

FIG. 35A is a diagram illustrating an example of QoE distribution in the area 600 at a certain time. In the example of FIG. 35A, the QoE of the location area “1” of the terminal 200 takes “1”, and the QoE of the areas “F”, “B”, “H” and “J” aligned in one vertical line also takes “1”.

For example, the base station 100-1 applies the JP mode when the mobility of the location area 600 is “low”. It may also be possible for the base station 100-1 to apply the JP mode even when the mobility of the location area 600 is “high”. The following description will be given on assumption that the JP mode is applied when the mobility is “low”.

Also, the base station 100-1 decides to execute cooperative communication targeted for the area 600, when the QoE of the location area 600 indicates deterioration and when the QoE of an area adjacent to the location area 600 indicates deterioration. It may also be possible for the base station 100-1 to determine to execute the cooperative communication targeted for the area 600 when the QoE of the location area 600 indicates deterioration.

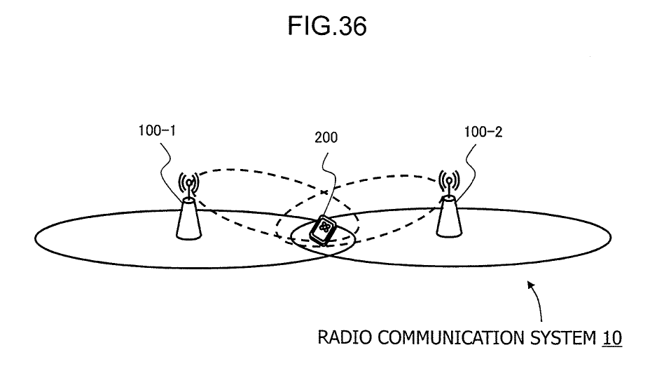

FIGS. 35B and 35C illustrates a state that the cooperative communication targeted for the area 600 is executed under the JP mode DPS. FIG. 36 illustrates a state that the cooperative communication targeted for the area 600 is executed under the JP mode JT.

In both cases, each base station 100-1, 100-2 executes the cooperative communication targeted for the overall area 600 rather than executing the cooperative communication targeted for each individual area 600, for example. This causes to improve the QoE of areas “F”, “B”, “H” and “J” in one vertical line to each satisfactory value, and also to improve interference. If the terminal 200 travels into these areas thereafter, communication quality is improved, so that the transmission of measurement report becomes less frequent.

This causes a reduced number of terminals 200 in the area 600 for which the cooperative communication is executed, so that the processing load of each base station 100-1, 100-2 can be reduced as compared with a case when the cooperative communication is executed for each individual terminal 200 at all times.

Additionally, with regard to the application of either the DPS mode or the JT mode out of the JP mode, each base station 100-1, 100-2 may appropriately determine according to, for example, a communication state, a design policy, etc.

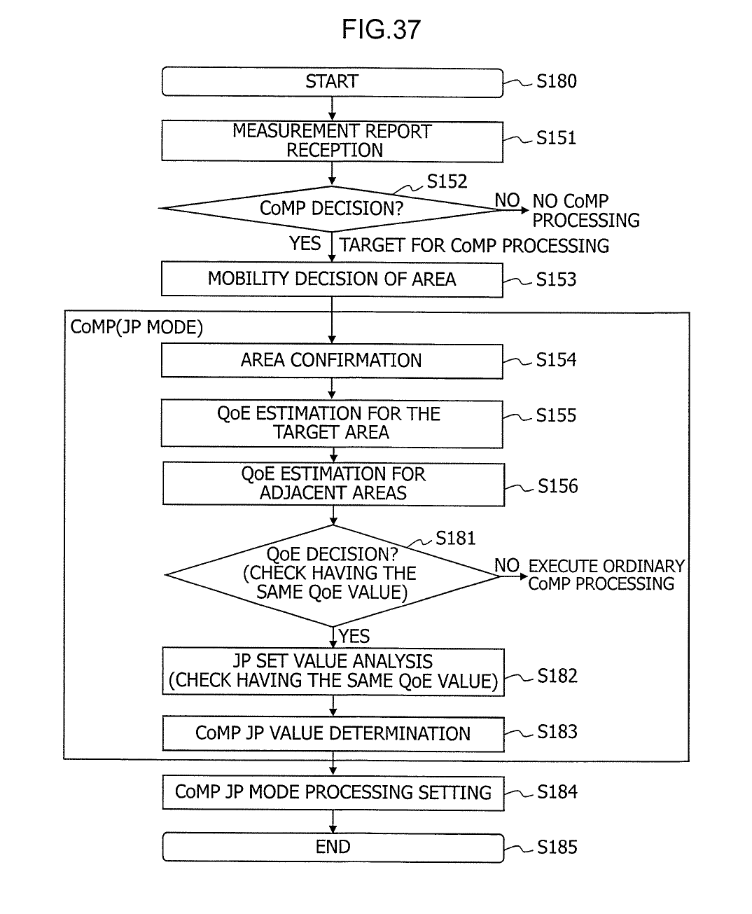

FIG. 37 is a diagram illustrating an operation example when the JP mode is applied. The same reference symbols are given to the same processing parts as in the operation example when the CB mode is applied.

The base station 100-1, on starting processing (S180), receives a measurement report (S151) to decide whether or not to execute ordinary cooperative communication (S152). When deciding not to execute the ordinary cooperative communication (N in S152), the base station 100-1 does not execute the ordinary cooperative communication, whereas when deciding to execute the ordinary cooperative communication (Y in S152), the base station 100-1 decides the mobility of the location area 600 (S153). In the present example, the base station 100-1 decides that the mobility of the location area “A” of the terminal 200 is “low”.

Next, the base station 100-1 executes the area 600 (S154), estimates the QoE of the target area 600 (S155) and estimates the QoE of each adjacent area (S156).

The base station 100-1 then decides whether or not to execute the cooperative communication targeted for the area 600 (S181). For example, as described earlier, the base station 100-1 may decide to execute the cooperative communication when the QoE of the location area 600 of the terminal 200 and the QoE of the adjacent area are “1”, or may decide to execute the cooperative communication when the QoE of the location area 600 is “1”. In the former case, the base station 100-1 may decide to execute the cooperative communication if the QoE of a plurality of adjacent areas takes “1”, or may decide to execute the cooperative communication if the QoE of at least one adjacent area takes “1”. When the decision is made using the QoE of the location area 600 only, the processing of S156 may be omitted. Such decision is made in the CoMP comparison & decision processing unit 148, similar to the case of the CB mode.

When deciding to execute the cooperative communication targeted for the area 600 (Y in S181), the base station 100-1 analyzes a set value for the JP mode (S182) to determine the set value (S183). As the set value, for example, radio resource allocation information to enable data transmission to the terminal 200 in the same frequency band at different timing, radio resource information to enable the transmission of the same data in the same frequency band at the same timing, and the like. Such analysis and determination of the set value is made, for example, in the CoMP comparison & decision processing unit 148, similar to the case of the CB mode.

Next, the base station 100-1 executes JP mode set processing (S184). For example, the base station 100-1 transmits the determined set value to the other base station 100-2, and receives a set value etc. generated in the other base station 100-2, so as to prepare for the cooperative communication in the JP mode.

The base station 100-1 then completes a series of processing (S185).

On the other hand, when deciding not to execute the cooperative communication targeted for the area 600 (N in S181), the base station 100-1 executes the ordinary cooperative communication targeted for the terminal 200.

<4.9 Example of Smart Meter System>

Next, a description will be given on an operation example when the present radio communication system 10 is applied to an M2M (Machine-to-Machine) system. The M2M system signifies a system in which, for example, machines connected to a computer network mutually exchange information, so as to automatically execute optimal control. For example, the M2M system can secure communication quality and reduce cost for network operation and maintenance without taking account of an environment condition, a device characteristic, etc. The examples of the M2M systems include the management of temperature and humidity of a greenhouse, the supervision of the state of a charging station for an electric automobile, etc., for example.

In the present operation example, a description will be given on a smart meter system as an example of the M2M system. For example, the smart meter system is a system provided for automatically transmitting, to supply companies of electric power, gas, etc., the usage of the electric power, the gas, etc. consumed in a corporation and a home. This enables each supply company to calculate an optimal exchange cycle of a supply device in the corporation and the home, and an optimal delivery route, for example.

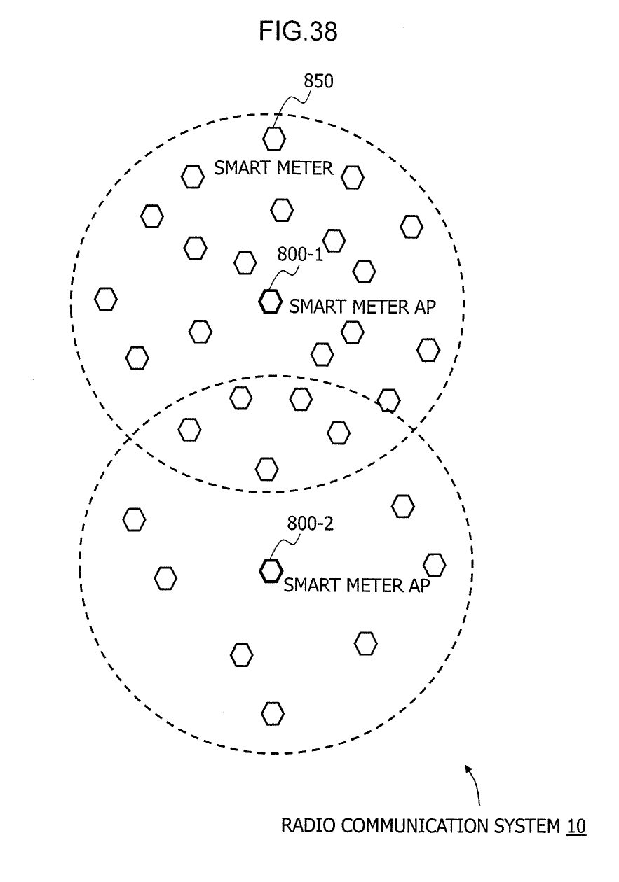

FIG. 38 is a diagram illustrating a configuration example of the present radio communication system 10 when applied to the smart meter system. In the present example, the radio communication system 10 may be referred to as a smart meter system 10, for example. The smart meter system 10 includes smart meter AP (Access Points) 800-1, 800-2 and a plurality of smart meters 850.

Each smart meter AP 800-1, 800-2 is a radio communication apparatus which radio communicates with each smart meter 850 in each communicable range of the self-station (which is depicted with a dotted line), for example. Each smart meter AP 800-1, 800-2 receives information, which is related to the usage of gas and electricity and transmitted from each smart meter 850, to collect information related to the usage of all smart meters 850 provided within the communicable range of the self-station.

Each smart meter 850 is installed at a housing etc., for example, and measures the usage etc. of gas and electricity used in the housing, to transmit information related to the measured usage etc. to the smart meter AP 800-1, 800-2 by radio. Therefore, the smart meter 850 is also a radio communication apparatus, for example. The smart meter 850 transmits the usage information etc. acquired from a sensor etc. to the smart meter AP 800-1, 800-2 by radio.

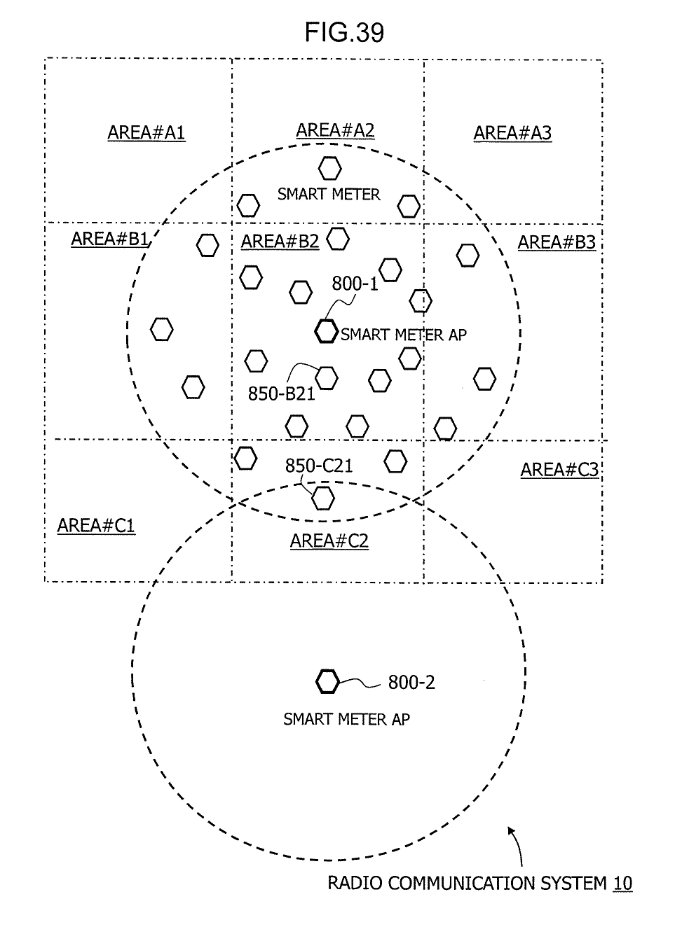

According to the present second embodiment, also the smart meter system 10 can execute cooperative communication targeted for the area 600. FIG. 39 is a diagram illustrating an example of the area 600. In the example of FIG. 39, the area 600 includes 9 small areas including an area #A1 through an area #C3.

FIG. 39 also illustrates an example that a new smart meter 850-B21 is installed at a new residential housing in the area #B2. In this case, there may be a case that the installation of the new smart meter 850-B21 causes the deteriorated QoE of the smart meter 850-C21 which is already installed in the area #C2. In regard to such deterioration of QoE, cooperative communication among the plurality of smart meter AP 800-1, 800-2 enables the prevention of QoE deterioration, for example.

A scheme for cooperative communication targeted for the area 600 which is executed by the plurality of smart meter AP 800-1, 800-2 includes, for example, operation of the overall operation example (for example, FIG. 12), the CB mode (for example, FIGS. 30A to 32), the CS mode (for example, FIGS. 33A to 34) and the JP mode (for example, FIGS. 35A to 37) mentioned above. In this case, because the smart meter 850 does not travel, in the mobility decision (for example, S153 in FIG. 32), the mobility is decided to be “low”, and therefore, the CB mode, the CS mode or the JP mode is applied.

For example, the smart meter AP 800-1 applies the CB mode, to execute beamforming to the area #C2, so as to improve the QoE of the area #C2 in which QoE is deteriorated. Thereafter, the QoE of the area #C2 is improved, so that communication quality is also improved.

In the smart meter system 10, because of the stationary installation of the smart meter, for example, once the improvement of QoE is established, the plurality of smart meter AP 800-1, 800-2 do not execute cooperative communication from then on.

Therefore, the execution of the cooperative communication targeted for the area 600 by the plurality of smart meter AP 800-1, 800-2 brings about the improvement of QoE, and thus the cooperative communication on the basis of each individual smart meter 850 at all times is no more executed. Therefore, according to the present smart meter system, the processing load of each smart meter AP 800-1, 800-2 can be reduced in comparison with a case when the cooperative communication is executed on the basis of each individual smart meter 850 at all times.

<4.10 Example of HetNet>

Next, a description will be given on a case when the radio communication system 10 is applied to a HetNet (or heterogeneous network). The HetNet is a network of a hierarchal configuration, including cells of a variety of sizes, such as a macro-cell, a pico-cell and a micro-cell, for example. The HetNet includes, for example, cells of different communication schemes (LTE, 3G, etc.) and different frequencies. Because of the hierarchal cell configuration, for example, the capacity of the overall radio communication system 10 can be improved.

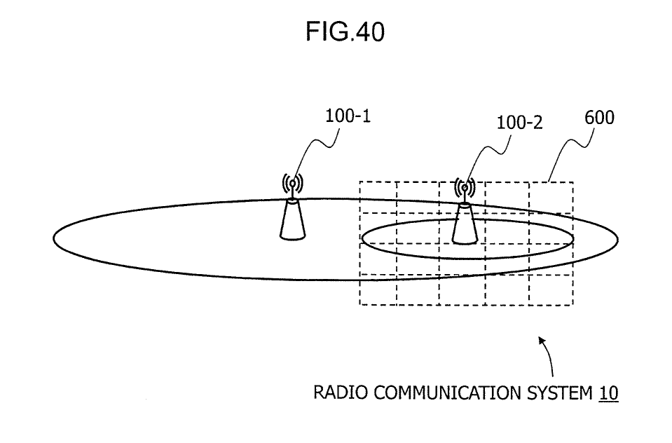

FIG. 40 is a diagram illustrating an example of the radio communication system 10 to which the HetNet is applied. As depicted in FIG. 40, the cell range of a base station 100-1 is larger than the cell range of a base station 100-2. An area 600 is set in a manner to cover the cell range of the base station 100-2. Similar to the above-mentioned examples, the area 600 is set in a region including a region of an overlapped cell range of the plurality of base stations 100-1, 100-2, for example.

In the present example, the base station 100-1 or a cell range formed by the base station 100-1 may be referred to as a “macro-cell”, and the base station 100-2 or a cell range formed by the base station 100-2 may be referred to as a “small cell”.

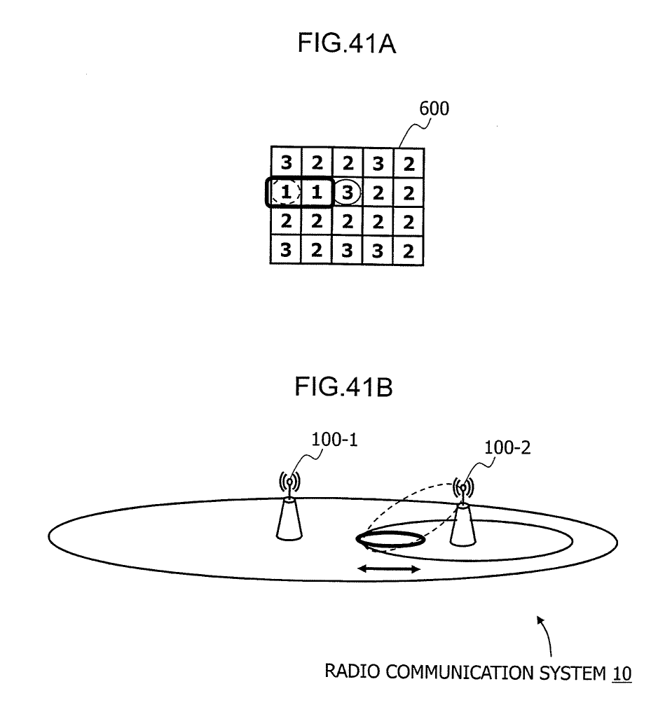

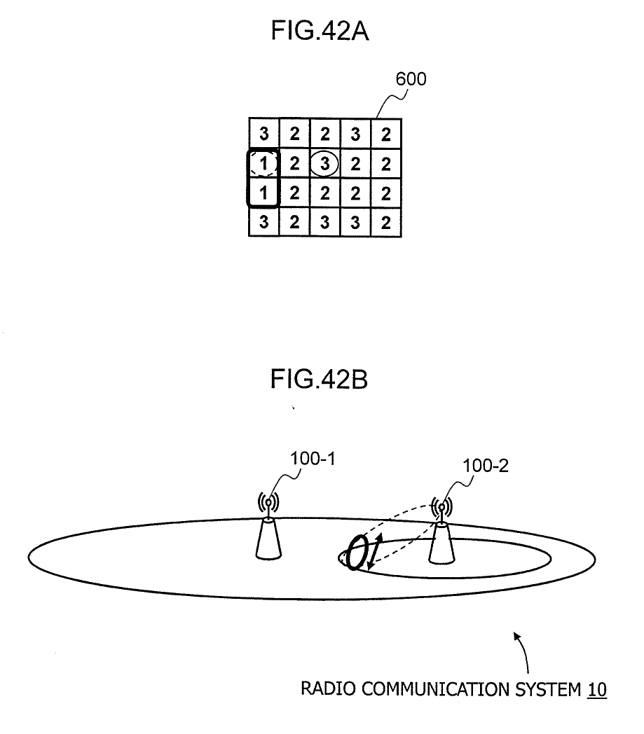

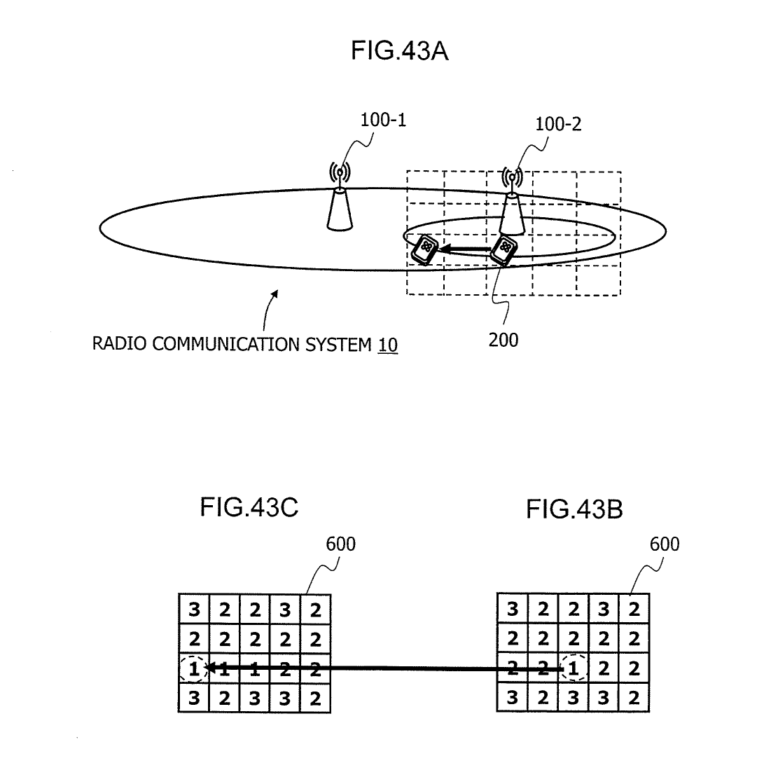

In the present radio communication system 10, similar to the above-mentioned examples, each base station 100-1, 100-2 calculates QoE, and selects a mode for the cooperative communication on the basis of the mobility decision on the area 600. For example, each base station 100-1, 100-2 selects the CB mode if the mobility of the area 600 in which the terminal 200 is located is decided to be “low”, whereas selects the CS mode if the mobility thereof is decided to be “high”. FIGS. 41A to 42B illustrate operation examples when the CB mode is applied, and FIGS. 43A to 43C illustrate operation examples when the CS mode is applied.

FIG. 41A is a diagram illustrating an example of QoE in the area 600.

Such QoE is stored in the knowledge DB 1465 of the base station 100-2, for example. In the area 600 depicted in FIG. 41A, an area depicted with a circle of a solid line indicates an area in which the base station 100-2 is arranged, whereas a circle of a dotted line indicates an area in which the terminal 200 is located. In this case, because the QoE of the area in which the terminal 200 is located takes “1”, and the QoE of an area adjacent to the location area takes “1”, the base station 100-1 decides to execute cooperative communication targeted for the area 600 (for example, Y in S157 of FIG. 32), to perform beamforming to the two areas based on the cooperative communication. In the example of FIG. 41B, a state of beamforming in the lateral direction in the figure is illustrated, whereas in the examples of FIGS. 42A and 42B, a state of beamforming in the vertical direction in the figure is illustrated.

FIG. 43A is a diagram illustrating an example when the terminal 200 travels to an area indicated with an arrow, after the lapse of a time T. As depicted in FIGS. 43B and 43C, the QoE of the location area of the terminal 200 takes “1”, and the QoE of the location area of the terminal 200 after the lapse of the time T takes “1”. Therefore, the base station 100-2 decides to execute the cooperative communication targeted for the area 600 (for example, Y in S172 of FIG. 34), and applies the CS mode for the terminal 200, for example.

The above-mentioned example is merely one example. For example, each base station 100-1, 100-2 may apply the CS mode when the mobility decision decides to be “low”, whereas the CB mode when decides to be “high”. Also, as to the mode each base station 100-1, 100-2 applies, the JP mode DPS and the JP mode JT may be applied in place of the CB mode and the CS mode.

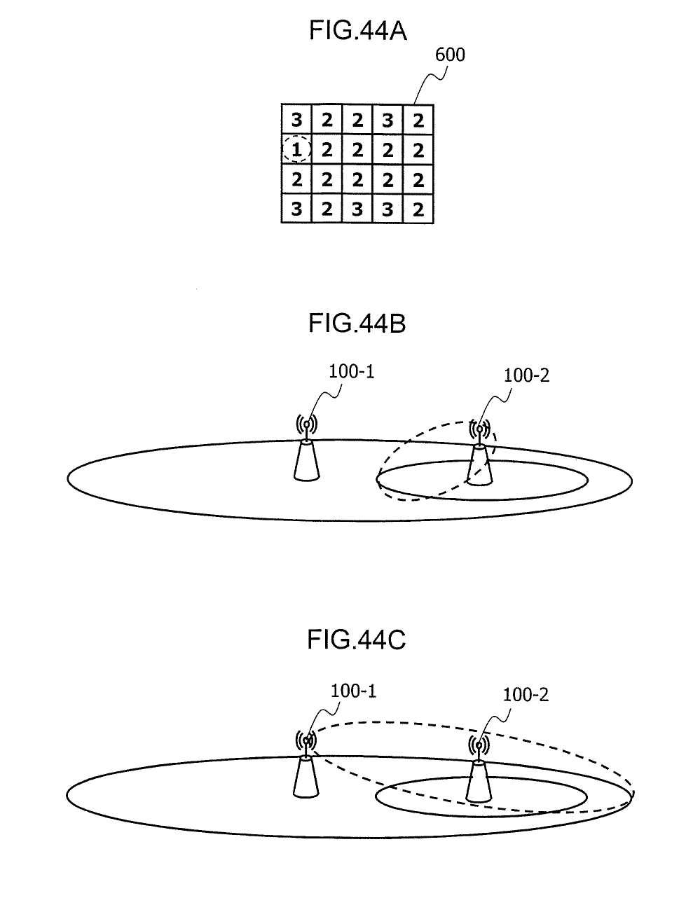

FIG. 44A is a diagram illustrating an operation example etc. when the JP mode DPS is applied. In the example of FIG. 44A, there is illustrated an example when the JP mode DPS is applied because of the mobility of an area in which the terminal 200 is located (as depicted with a circle mark of a dotted line) is decided to be “low”. In this case, as depicted in FIGS. 44B and 44C, each base station 100-1, 100-2 executes radio communication targeted for an area which includes the location area of the terminal 200, using an antenna 110 having directivity.

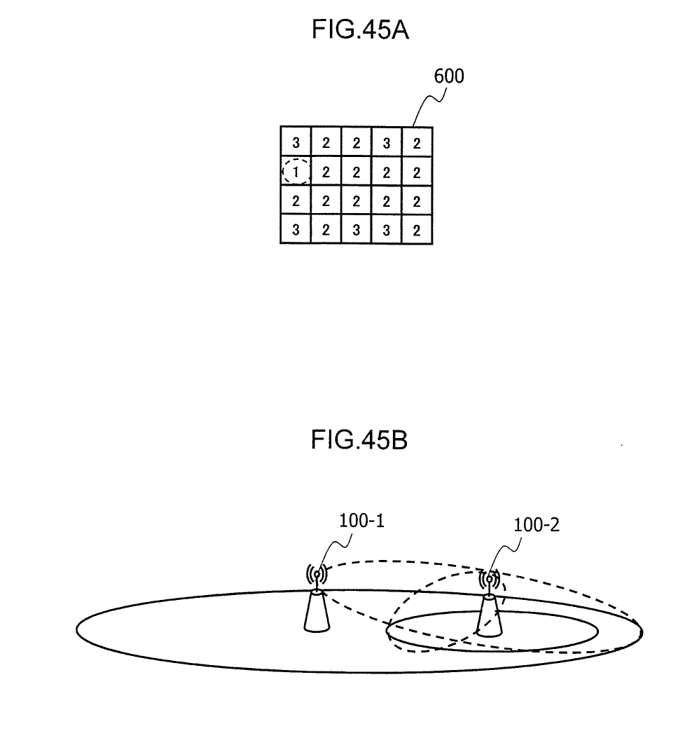

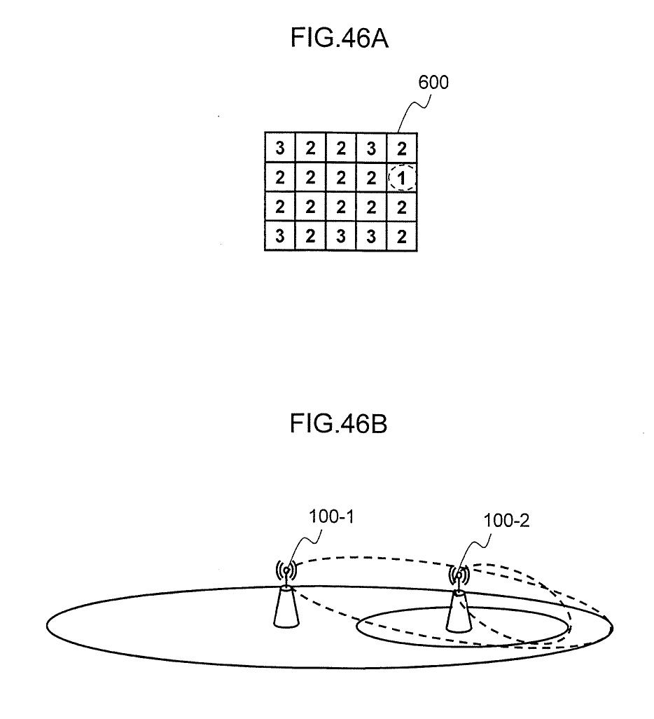

FIGS. 45A to 46B illustrate operation examples when the JP mode JT is applied. In the operation examples also, for example, there is illustrated an example in which the JP mode JT is applied because the mobility of the area in which the terminal 200 is located is decided to be “low”. Also in this case, similar to the example of the JP mode DPS, each base station 100-1, 100-2 executes radio communication targeted for an area which includes the location area of the terminal 200, using an antenna 110 having directivity.

### Other Embodiments

In the second embodiment, the description has been given based on that each base station 100-1, 100-2 applies the CB mode when the mobility of the area 600 is “low”, so as to execute the flowchart as depicted in FIG. 32. Also, the description has been given based on that each base station 100-1, 100-2 applies the CS mode when the mobility of the area 600 is “high”, so as to execute the flowchart as depicted in FIG. 34.

For example, it may also be possible for each base station 100-1, 100-2 to execute the flowchart as depicted in FIG. 32 when the mobility of the area 600 is “low”, and execute the flowchart as depicted in FIG. 34 when the mobility of the area 600 is “high”.

In this case, in S158-S160 of FIG. 32, by the analysis and the setting of the CS set value in place of the analysis and the setting of the BF set value, each base station 100-1, 100-2 can apply the CS mode when the mobility of the area 600 is “low”. Also, in place of the analysis and the setting of the BF set value in S158-S160 of S32, by the analysis and the setting of set values for the JP mode DPS and the JP mode JT, it is possible to apply these modes.

On the other hand, in S173-S175 of FIG. 34, by the analysis and the setting of the set values for the BF, the JP mode DPS or the JP mode JT in place of the setting and the analysis of the CS set value, it is possible to apply the CB mode, the JP mode DPS or the JP mode JT when the mobility is “high”.

The above analysis and the setting of each set value may be achieved typically by the execution of S158-S160 of FIG. 32, S173-S174 of FIG. 34 and S182-S184 of FIG. 37.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A base station apparatus that performs radio communication with a terminal apparatus, the base station apparatus comprising:
a receiver configured to receive information from the terminal apparatus; and
a processor configured to perform radio communication in cooperation with another base station apparatus based on the information, for a region in which the terminal apparatus is located.

2. The base station apparatus according to claim 1, wherein
the processor is configured to perform radio communication by a first scheme or a second scheme in cooperation with the other base station apparatus, according to an attribute of the region.

3. The base station apparatus according to claim 1, wherein
the processor is configured to perform radio communication by a first scheme or a second scheme in cooperation with the other base station apparatus, according to whether or not possibility of movement of the terminal apparatus in the region is higher than a mobility decision threshold.

4. The base station apparatus according to claim 1, wherein
a plurality of other terminal apparatuses locates in the region, and
the processor is configured to
perform radio communication by a first scheme in cooperation with the other base station apparatus for the region, when a number of the other terminal apparatus that a moving distance of the other terminal apparatus is equal to or greater than a mobility decision threshold is equal to or greater than a number decision threshold in the region, and
perform radio communication by a second scheme in cooperation with the other base station apparatus for the region, when the moving distance is lower than the mobility decision threshold or the number of the other terminal apparatus that the moving distance is equal to or higher than the mobility decision threshold is lower than the number decision threshold.

5. The base station apparatus according to claim 2, wherein
the processor is configured to determine the attribute of region based on communication history information in case that the terminal apparatus performs radio communication with the base station apparatus.

6. The base station apparatus according to claim 1, wherein
the processor is configured to perform radio communication in cooperation with the other base station apparatus for the region, based on quality of user experience experienced by a user in case that the terminal apparatus receives data transmitted from the base station apparatus.

7. The base station apparatus according to claim 1, wherein
the region is divided into a first to third regions, and
the processor is configured to perform radio communication in cooperation with the other base station apparatus for the region, based on
a first quality of user experience in the first region in which the terminal apparatus locates and a second quality of user experience in the second region adjacent to the first region, or
the first quality of user experience and a third quality of user experience in the third region to which the terminal apparatus moves after a prescribed time elapses.

8. The base station apparatus according to claim 6, wherein
the processor is configured to
perform radio communication in cooperation with the other base station apparatus for the region, when the first quality of user experience and the second quality of user experience is equal to or lower than a quality experience threshold value, the third quality of user experience is lower than the first quality of user experience, or the third quality of user experience and the first quality of user experience is equal to or lower than the quality experience threshold value, and
perform radio communication in cooperation with the other base station apparatus without performing radio communication in cooperation with the other base station apparatus for region, when the first quality of user experience and the second quality of user experience is higher than the quality experience threshold value, the third quality of user experience is equal to or higher than the first quality of user experience, or the third quality of user experience and the first quality of user experience is higher than the quality experience threshold value.

9. The base station apparatus according to claim 6, wherein
the processor is configured to calculate the quality of user experience, based on delay time from reception of a service start request transmitted from the terminal apparatus to transmission of a service start notification to the service start request to the terminal apparatus and traffic amount of data with respect to a service requested by the service start request.

10. The base station apparatus according to claim 7, wherein
the processor is configured to calculate the third region to which the terminal apparatus moves after the prescribed time elapses, based on position information transmitted from the terminal apparatus.

11. The base station apparatus according to claim 2, wherein
the first scheme is any one of
a third scheme that the base station apparatus and the other base station apparatus set beamforming in cooperation with each other and the base station apparatus or the other base station apparatus transmits data,
a fourth scheme that the base station apparatus and the other base station apparatus perform a scheduling in cooperation with each other and the base station apparatus or the other base station apparatus transmits data,
a fifth scheme that the base station apparatus or the other base station apparatus transmit data each time instant, or
a sixth scheme that the base station apparatus and the other base station apparatus transmit data at the same time, and
the second scheme is any one of the third to sixth schemes which is not selected by the first scheme.

12. The base station apparatus according to claim 1, wherein
the processor is configured to perform radio communication with the terminal apparatus locating in the region and which is movable or fixed.

13. The base station apparatus according to claim 1, wherein
a range capable of radio communication of the base station apparatus is larger than a range capable of radio communication of the other base station apparatus and includes the range capable of radio communication of the other base station apparatus.

14. The base station apparatus according to claim 1, wherein
the region is a region where a range capable of radio communication of the base station apparatus and a range capable of radio communication of the other base station apparatus overlap.
